(19) United States
(12) Patent Application Publication
(10) Pub. No.: US 2013/0145244 A1
(43) Pub. Date: Jun. 6, 2013

(54) QUICK ANALYSIS TOOL FOR SPREADSHEET APPLICATION PROGRAMS

(71) Applicants: Chad Barry Rothschiller, Edmonds, WA (US); Thomas Scott Constantine, Redmond, WA (US); Andrew James Becker, Duvall, WA (US); Dafna Chen, Issaquah, WA (US); Gabhan Berry, Carnation, WA (US); Xiaohui Pan, Sammamish, WA (US); Igor Borisov Peev, Seattle, WA (US)

(72) Inventors: Chad Barry Rothschiller, Edmonds, WA (US); Thomas Scott Constantine, Redmond, WA (US); Andrew James Becker, Duvall, WA (US); Dafna Chen, Issaquah, WA (US); Gabhan Berry, Carnation, WA (US); Xiaohui Pan, Sammamish, WA (US); Igor Borisov Peev, Seattle, WA (US)

(73) Assignee: Microsoft Corporation, Redmond, WA (US)

(21) Appl. No.: 13/311,541

(22) Filed: Dec. 5, 2011

(51) Int. Cl. G06F 3/048; G06F 17/00

(52) U.S. Cl. 715/212

(57) ABSTRACT

A quick analysis tool is configured to present one or more data analysis features that are tailored to the data in a selected portion of a spreadsheet document. The quick analysis tool may provide a quick analysis tool entry button, the selection of which causes a contextual user interface to be displayed. The contextual user interface facilitates a user to easily access one or more data analysis features. The quick analysis tool also provides a mechanism by which a user can preview and/or apply one or more of these data analysis features while bypassing the potentially steep learning curve and traditionally high barrier of entry for new or otherwise less advanced users of the spreadsheet application. Intermediate or otherwise more advanced users of the spreadsheet application will also benefit from the quick analysis tool because of improved efficiency for applying data analysis features to data within a spreadsheet document.

### BACKGROUND

Some spreadsheet application programs, such as MICROSOFT EXCEL, available from Microsoft of Redmond, Wash., provide powerful analytic features such as, charting, formulas, sparklines, conditional formatting, and pivot tables, among others. Many users are unaware of some or all of these features. Other users are aware of these features, but do not know how to use them. These users are sometimes unwilling to learn on-the-fly through trial and error or by using built-in help functions and/or online tutorials. Still other users are aware of these features, but do not want to use these features because they are intimidated by the apparent complexity of these features, or are afraid of trying the feature due to the possibility of the feature modifying their data into an undesirable state.

Today, solutions exist that advertise features and/or try to entice a user to use a particular feature. For example, some social networking applications utilize a backend component to determine criteria upon which to base friend suggestions and a user interface component to show friend suggestions to users. Other solutions exist for digital media distribution applications to make suggestions for digital media such as music, movies, and application programs. Similar suggestion mechanisms have been implemented by online retailers to make product suggestions based upon a user's purchase history, online store browsing habits, and/or other criteria.

It is with respect to these and other considerations that the disclosure made herein is presented.

### SUMMARY

Concepts and technologies are described herein for a quick analysis tool configured to present one or more data analysis features that are tailored to the data in a selected portion of a spreadsheet document. In accordance with some of the concepts and technologies disclosed herein, the quick analysis tool provides a quick analysis tool entry button, the selection of which causes a contextual user interface to be displayed. The contextual user interface facilitates a user to easily access one or more data analysis features. The quick analysis tool provides a mechanism by which a user can preview exactly what is going to happen to their spreadsheet document before actually applying the feature, which bypasses much of the fear, hesitancy, or anxiety that a user might have when exploring an unfamiliar feature, or when exploring a feature they feel is more complex than they can comfortably configure to their satisfaction. In other words, the preview provides the user with a non-destructive preview so that the user can see the potential changes to their spreadsheet document without anything actually changing in their spreadsheet document. The quick analysis tool also provides a mechanism by which a user can apply one or more of these data analysis features while bypassing the potentially steep learning curve and traditionally high barrier of entry for new or otherwise less advanced users of the spreadsheet application. Intermediate or otherwise more advanced users of the spreadsheet application will also benefit from the quick analysis tool because of improved efficiency for applying data analysis features to data within a spreadsheet document.

According to one aspect disclosed herein, an illustrative method includes receiving a selection of a range of cells from a spreadsheet document, displaying a quick analysis tool entry button in proximity to the selection of the range of cells, determining one or more data types of data included in the range of cells in the spreadsheet document, and determining one or more data analysis features suitable for application to the one or more data types. The illustrative method further includes receiving a selection of the quick analysis tool entry button, displaying one or more user-selectable representations for the one or more data analysis features in response to receiving the selection of the quick analysis tool entry button, receiving a selection of a particular user-selectable representation, and applying the particular data analysis feature to the data included in the range of cells in response to receiving the selection of the particular user-selectable representation.

According to another aspect disclosed herein, an illustrative method includes receiving a selection of two or more cells within a spreadsheet document, and displaying a quick analysis tool user interface in response to receiving the selection of the two or more cells within the spreadsheet document. The quick analysis tool user interface includes one or more user-selectable representations for one or more data analysis features that are applicable to data included in the two or more cells.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an illustrative operating environment for various embodiments disclosed herein.

FIGS. 2A-2B are flow diagrams illustrating aspects of a method for utilizing a quick analysis tool to advertise data analysis features of a spreadsheet application based upon a selection of a range of cells within a spreadsheet document, according to an illustrative embodiment.

FIG. 3 is a flow diagram illustrating aspects of a method for searching a selected range of cells for data types, according to an illustrative embodiment.

FIG. 4 is a flow diagram illustrating aspects of a method for determining data types for cell values within a selected range of cells, according to an illustrative embodiment.

FIGS. 5A-5F are a user interface diagrams illustrating aspects of a quick analysis tool, according to various illustrative embodiments.

FIG. 6 is a diagram illustrating an illustrative tablet device with a touch-enabled quick analysis tool user interface, according to an illustrative embodiment.

FIG. 7 is a diagram illustrating an illustrative tablet device with a touch-enabled quick analysis tool user interface, according to another illustrative embodiment.

FIG. 8 is a computer architecture diagram illustrating an illustrative computer hardware and software architecture for a computing system capable of implementing aspects of the embodiments presented herein.

FIG. 9 is a diagram illustrating a distributed computing environment capable of implementing aspects of the embodiments presented herein.

FIG. 10 is a computer architecture diagram illustrating a computing device architecture for a computing device capable of implementing aspects of the embodiments presented herein.

### DETAILED DESCRIPTION

The following detailed description is directed to concepts and technologies for a quick analysis tool configured to present one or more data analysis features that are tailored to the data in a selected portion of a spreadsheet document. According to some of the concepts and technologies described herein, the quick analysis tool provides a quick analysis tool entry button, the selection of which causes a contextual user interface to be displayed. The contextual user interface facilitates a user to easily access one or more data analysis features. The quick analysis tool also provides a mechanism by which a user can preview and/or apply one or more of these data analysis features while bypassing the potentially steep learning curve and traditionally high barrier of entry for new or otherwise less advanced users of the spreadsheet application. Intermediate or otherwise more advanced users of the spreadsheet application will also benefit from the quick analysis tool because of improved efficiency for applying data analysis features to data within a spreadsheet document.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodologies for utilizing a quick analysis tool to advertise data analysis features of a spreadsheet application based upon a selection of a range of cells within a spreadsheet document and other aspects will be presented.

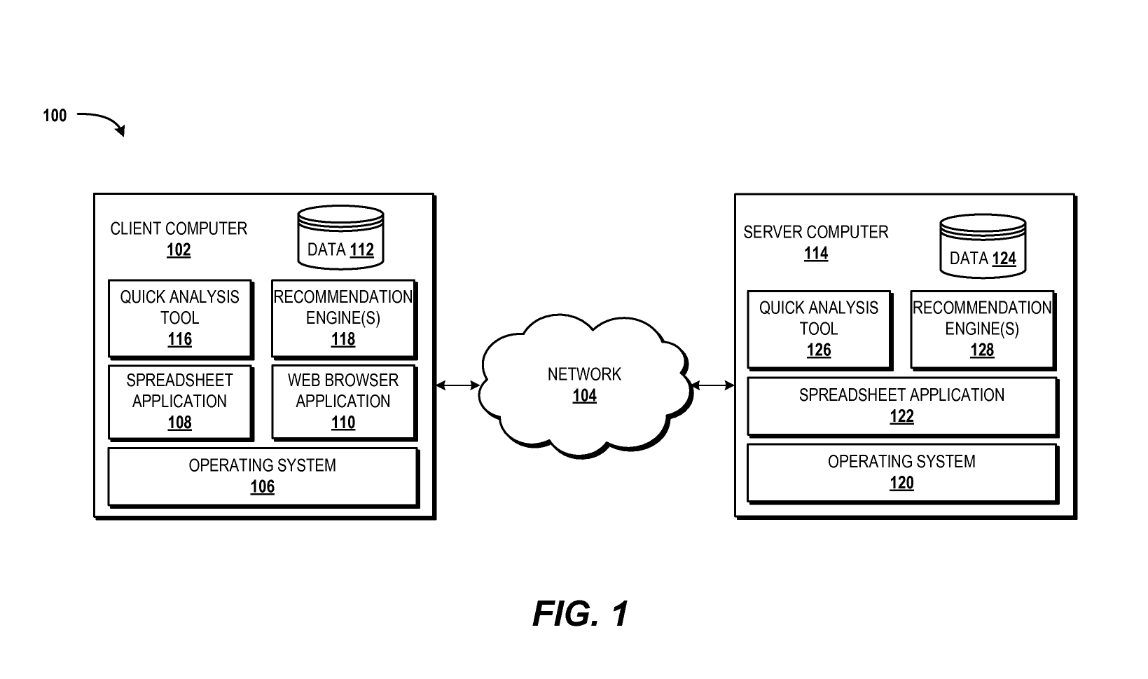

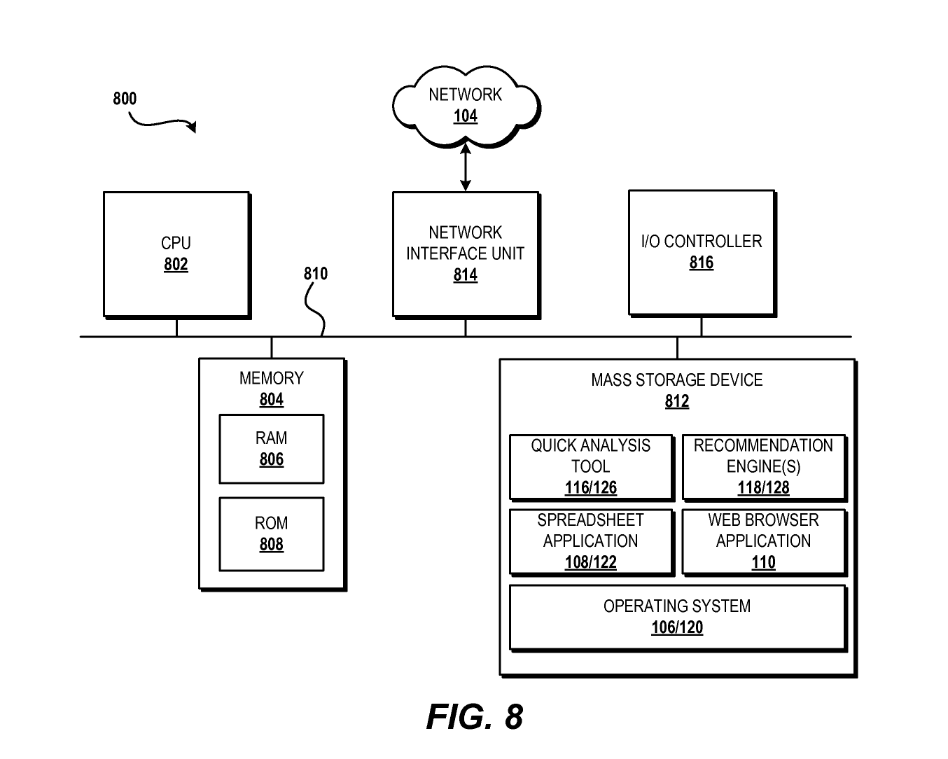

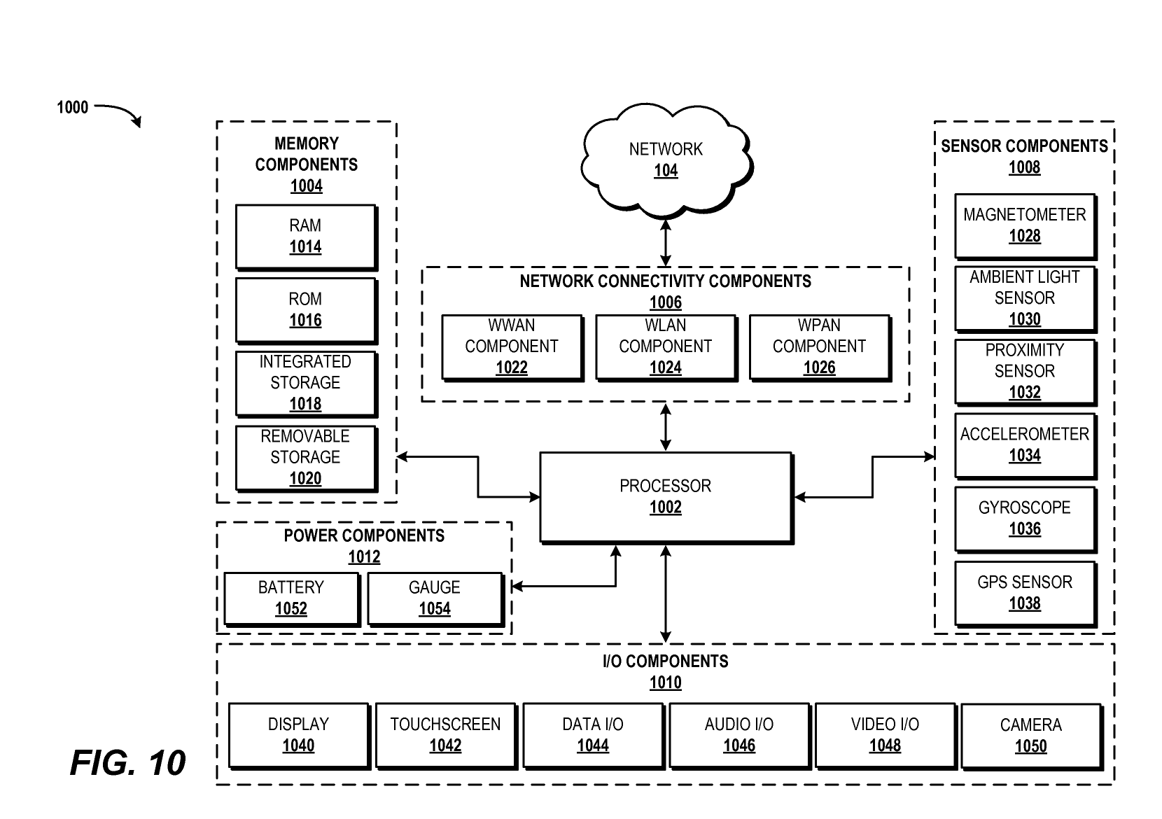

Referring now to FIG. 1, aspects of one operating environment 100 for the various embodiments presented herein will be described. The operating environment 100 shown in FIG. 1 includes a client computer 102 operating on or in communication with a network 104. In some embodiments, the client computer 102 is a desktop computer, a laptop computer, a notebook computer, an ultra-portable computer, a netbook computer, or a computing device such as a mobile telephone, a tablet device, a slate device, a portable video game device, or the like. Illustrative architectures for the client computer 102 are illustrated and described herein below with reference to FIGS. 8 and 10. The client computer 102 is configured to execute an operating system 106 and one or more application programs such as, in the illustrated embodiment, a spreadsheet application 108, a web browser application 110, and/or one or more other applications. The network 104 may be an internet, the Internet, an intranet, or an extranet. Access to the network 104 may be provided via one or more wired or wireless access networks (not shown), as will be understood by those skilled in the art.

The operating system 106 is a computer program for controlling the operation of the client computer 102. The application programs are executable programs configured to execute on top of the operating system 106 to provide various functionality described herein. The spreadsheet application 108 is an application program configured to receive and display data 112 in cells in a simulated worksheet of rows and columns, referred to herein as a spreadsheet document. One or more formulas can be applied to all or a portion of the data 112 to perform calculations. The data 112 can alternatively or additionally be used as the basis for creating tables, charts, sparklines, and other visualizations.

The web browser application 110 is an application program through which a user can access information resources on the World Wide Web (“the Web”) via the network 104. Moreover, the web browser application 110 allows a user to access information and various functions provided by a server computer 114 via one or more web pages, as will be described in greater detail below.

In some embodiments, the spreadsheet application 108 is a stand-alone application such as MICROSOFT EXCEL, available from Microsoft Corporation of Redmond, Wash., APPLE NUMBERS, available from Apple Inc. of Cupertino, Calif., OPENOFFICE CALC, available from Oracle Corporation of Redwood Shores, Calif., or the like. In some embodiments, the spreadsheet application 108 is part of an application suite such a MICROSOFT OFFICE, available from Microsoft Corporation of Redmond, Wash., APPLE IWORK, available from Apple Inc. of Cupertino, Calif., OPENOFFICE, available from Oracle Corporation of Redwood Shores, Calif., or the like. In some embodiments, the spreadsheet application 108 is configured to allow a user to embed a worksheet in another application such as a word processing application, a presentation application, a web page design application, or the like.

As will be described in greater detail herein, the spreadsheet application 108 is configured to utilize a quick analysis tool 116 to present one or more data analysis features tailored to the data in a selected data set of a spreadsheet document. In some embodiments, the quick analysis tool 116 provides a quick analysis tool entry button, the selection of which causes a contextual user interface to be displayed. The contextual user interface facilitates a user to easily access one or more data analysis features such as, but not limited to, formulas, conditional formatting, sparklines, tables, charts, and pivot tables, and the like. Moreover, the quick analysis tool 114 provides a mechanism by which a user can preview and/or apply one or more of these data analysis features while bypassing the hesitancy and uncertainty the user may have when working with new or complex features, as well as bypassing the potentially steep learning curve and traditionally high barrier of entry for new or otherwise less advanced users of the spreadsheet application 108. Intermediate or otherwise more advanced users of the spreadsheet application 108 will also benefit from the quick analysis tool 116 because of improved efficiency for applying data analysis features to data within a spreadsheet document.

In some embodiments, the quick analysis tool 116 is provided as part of the spreadsheet application 108. In other embodiments, the quick analysis tool 116 is provided as an add-on or an add-in to the spreadsheet application 108 and/or another application, such as the web browser application 110, executing on the client computer 102.

In some embodiments, the quick analysis tool 116 functions, at least in part, as an advertisement for one or more data analysis features. In some embodiments, the features advertised by the quick analysis tool 116 include one or more new features added through an update to the spreadsheet application 108. In some embodiments, the features advertised by the quick analysis tool 116 include one or more new features added in a new version of the spreadsheet application 108. In some embodiments, the features advertised by the quick analysis tool 116 include one or more features selected by a developer of the spreadsheet application 108, a distributer of the spreadsheet application 108, and/or some other party who desires to advertise one or more features. In some embodiments, the features advertised by the quick analysis tool 116 include one or more features selected by the spreadsheet application 108 by executing one or more algorithms provided by one or more recommendation engines 118.

In some embodiments, the recommendation engines 118 include, but are not limited to, one or more recommendation engines for each data analysis feature that is to be made available via the quick analysis tool 116. The recommendation engines 118 are configured to receive a data set, such as a selection of a range of cells within a spreadsheet document, as input and provide one or more recommended features, or recommended variations of these features, tailored specifically for the data set provided as input, for display via the quick analysis tool 116 as output. The details of the algorithm(s) used by a particular recommendation engine to determine which data analysis features to provide to the quick analysis tool 116 are beyond the scope of this disclosure.

In some embodiments, the recommendation engines 118 include a conditional formatting recommendation engine that utilizes one or more algorithms for determining one or more conditional formatting features, conditional formatting types, and/or particular configurations of a particular type of conditional formatting rule to be provided to the quick analysis tool 116 based upon a given data set. In some embodiments, the recommendation engines 118 include a chart recommendation engine that utilizes one or more algorithms for determining one or more chart features, chart types, and/or particular configurations of a particular chart type to be provided to the quick analysis tool 116 based upon a given data set. In some embodiments, the recommendation engines 118 include a table recommendation engine that utilizes one or more algorithms for determining one or more table features to be provided to the quick analysis tool 116 based upon a given data set. In some embodiments, the recommendation engines 118 include a pivot table recommendation engine that utilizes one or more algorithms for determining one or more pivot table layouts, field groupings, and/or individual data field placement (e.g., on rows, on columns, as summarized values, and the like), as well as summary calculation options (e.g., sum, average, count, and the like), and other pivot table features to be provided to the quick analysis tool 116 based upon a given data set. In some embodiments, the recommendation engines 118 include a sparkline recommendation engine that utilizes one or more algorithms for determining one or more sparkline features to be provided to the quick analysis tool 116 based upon a given data set. In some embodiments, the recommendation engines 118 include a totals recommendation engine that utilizes one or more algorithms for determining one or more totals feature to be provided to the quick analysis tool 116 based upon a given data set.

The server computer 114, in some embodiments, is a desktop computer, a laptop computer, a notebook computer, an ultra-portable computer, a netbook computer, or a computing device such as a mobile telephone, a tablet device, a slate device, a portable video game device, or the like. Illustrative architectures for the server computer 114 are illustrated and described herein below with reference to FIGS. 8 and 10. The illustrated server computer 114 is configured to execute a server operating system 120 and one or more application programs such as a server spreadsheet application 122 and/or one or more other applications. The server operating system 120 is a computer program for controlling the operation of the server computer 112. The application programs are executable programs configured to execute on top of the server operating system 120 to provide various functionality described herein.

The server spreadsheet application 122, in some embodiments, is a web-based application program configured to receive and display data 124 in cells in a spreadsheet document. One or more formulas can be applied to all or a portion of the data 124 to perform calculations. The data 124 can alternatively or additionally be used as the basis for creating tables, charts, sparklines, and other visualizations.

In some embodiments, the server spreadsheet application 122 is a web-based version of MICROSOFT EXCEL, available from Microsoft Corporation of Redmond, Wash., APPLE NUMBERS, available from Apple Inc. of Cupertino, Calif., OPENOFFICE CALC, available from Oracle Corporation of Redwood Shores, Calif., or the like. Alternatively, in some embodiments, the server spreadsheet application 122 is an exclusively web-based spreadsheet application such as GOOGLE SPREADSHEETS, available from Google of Mountain View, Calif. In some embodiments, the server spreadsheet application 122 is part of a web-based application suite such a MICROSOFT OFFICE 365, available from Microsoft Corporation of Redmond, Wash., GOOGLE DOCS, available from Google of Mountain View, Calif., or the like. In any case, the server spreadsheet application 122 may be made available via one or more web pages and may be accessed by a user via the web browser application 110 executing on the client computer 102.

In some embodiments, the server spreadsheet application 122 is configured to allow a user to embed a spreadsheet document in another application (web-based or traditional), such as a word processing application, presentation application, web page design application, or the like. In some embodiments, the server computer 114 is configured to execute the server spreadsheet application 122 and the client computer 102 is configured to access the server computer 114 to interact with the server spreadsheet application 122 in a client/server configuration. In these embodiments, the server spreadsheet application 122 may provide functionality that is identical to the spreadsheet application 108.

The server spreadsheet application 122 is configured to utilize a server quick analysis tool 126 to present one or more data analysis features tailored to the data in a selected data set of a spreadsheet document. In some embodiments, the server quick analysis tool 126 provides a quick analysis tool entry button, the selection of which causes a contextual user interface to be displayed. The contextual user interface facilitates a user to easily access one or more data analysis features such as, but not limited to, formulas, conditional formatting, sparklines, tables, charts, and pivot tables, and the like. Moreover, the server quick analysis tool 126 provides a mechanism by which a user can preview and/or apply one or more of these data analysis features while bypassing the hesitancy and uncertainty the user may have when working with new or complex features, as well as bypassing the potentially steep learning curve and traditionally high barrier of entry for new or otherwise less advanced users of the server spreadsheet application 122. Intermediate or otherwise more advanced users of the server spreadsheet application 122 will also benefit from the server quick analysis tool 126 because of improved efficiency for applying data analysis features to data within a spreadsheet document.

The illustrated server computer 114 also includes one or more recommendation engines 128. The recommendation engines 128 may be configured like the recommendation engines 118 described above.

In some embodiments, the server quick analysis tool 126 is provided as part of the server spreadsheet application 122. In other embodiments, the server quick analysis tool 126 is provided as an add-on or an add-in to the server spreadsheet application 122 and/or another application (not shown) executing on the server computer 114.

It should be understood that some implementations of the operating environment 100 include multiple client computers 102, multiple networks 104, and/or multiple server computers 114. It should also be understood that multiple operating systems 106, multiple spreadsheet applications 108, multiple web browser applications 110, multiple quick analysis tools 116, and/or multiple recommendation engines 118 may be used by the client computer 102. It should also be understood that multiple server operating systems 120, multiple server spreadsheet applications 122, multiple server quick analysis tools 126, and/or multiple server recommendation engines 128 may be used by the server computer 112. Thus, the illustrated embodiments should be understood as being illustrative, and should not be construed as being limiting in any way unless otherwise noted.

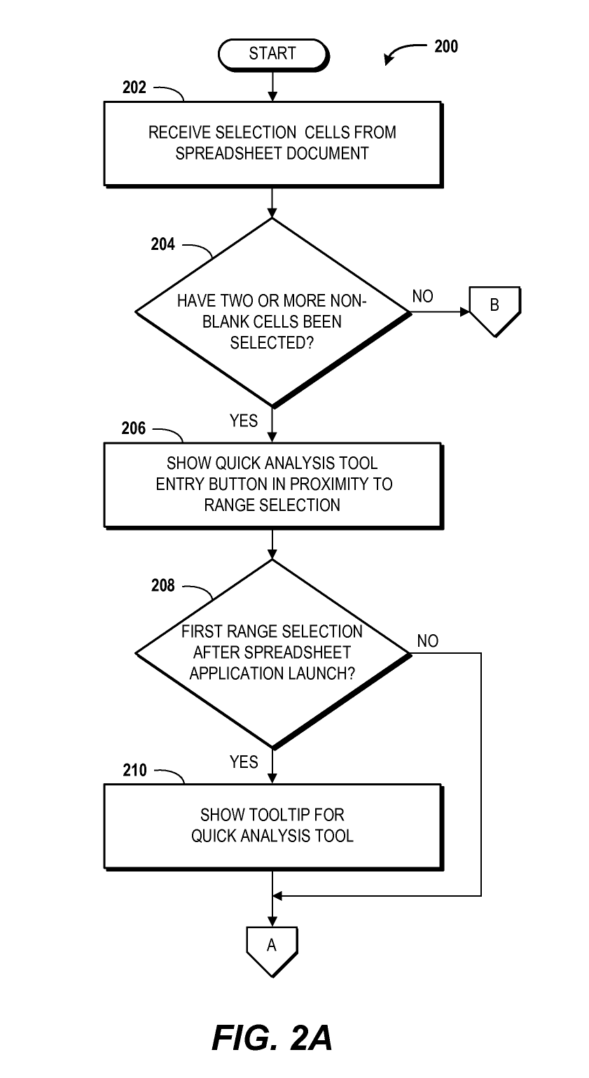

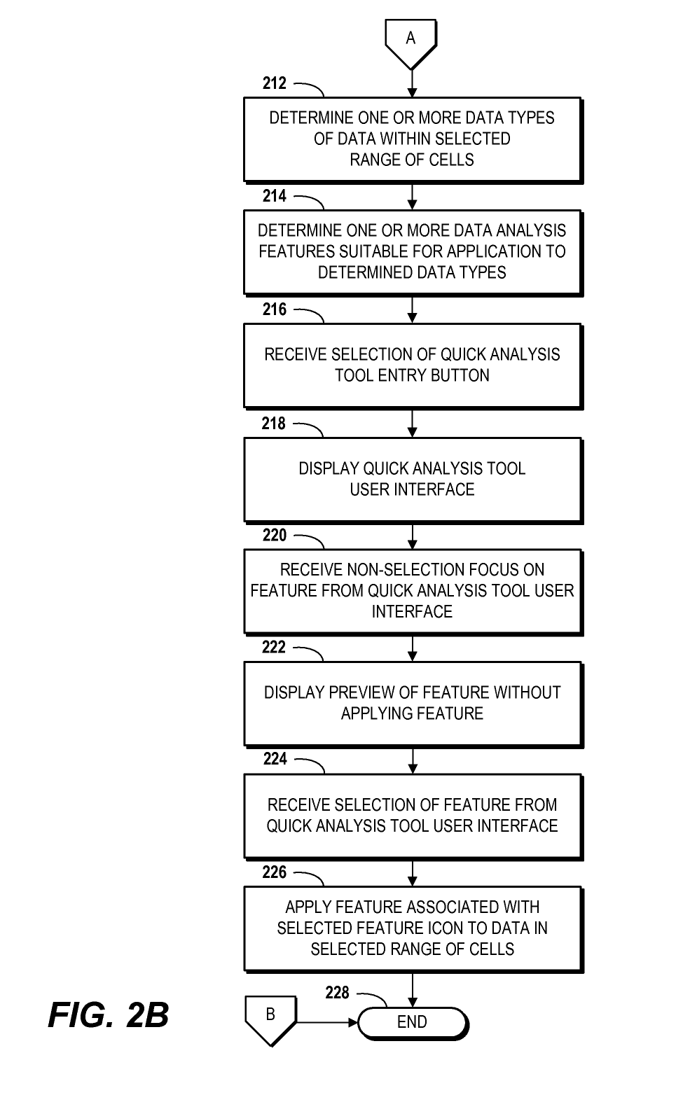

Turning now to FIGS. 2A-2B, aspects of a method 200 for utilizing a quick analysis tool to advertise data analysis features of a spreadsheet application based upon a selection of cells within a spreadsheet document, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

The operations of the method 200 are described herein below as being implemented, at least in part, by the spreadsheet application 108, the quick analysis tool 116, and/or the recommendation engine 118 executing on the client computer 102. One or more of the operations of the method 200 may alternatively or additionally be implemented, at least in part, by the similar components of the server computer 114.

Turning first to FIG. 2A, the method 200 begins and proceeds to operation 202, wherein the spreadsheet application 108 receives a selection of one or more cells from a spreadsheet document. From operation 202, the method 200 proceeds to operation 204, wherein the spreadsheet application 108 determines if the selected cells include two or more non-blank cells. The selection of two or more non-blank cells is referred to herein as a range, a cell range, or a range of cells. If the spreadsheet application 108 determines, at operation 204, that a range of cells has been selected, the method 200 proceeds to operation 206, wherein a quick analysis tool entry button of the quick analysis tool 116 is shown in proximity to the selected range of cells. The quick analysis tool entry button may take various forms including, but not limited to, text, graphic, icon, video, picture, symbol, some combination thereof, and the like. It is contemplated that the quick analysis tool entry button may include an audio component, such as an audio alert.

In some embodiments, the quick analysis tool entry button is considered to be in proximity to a selected range of cells if the quick analysis tool entry button is positioned within a specified distance of at least one of the cells within the selected range of cells. This distance may be in millimeters, centimeters, inches, pixels, or some other unit of distance. In some embodiments, the quick analysis tool entry button is considered to be in proximity to a selected range of cells if the quick analysis tool entry button at least partially intersects at least one of the cells within the selected range of cells. In some embodiments, the quick analysis tool entry button is shown elsewhere within the spreadsheet application 108 so as to be visible to the user but is not considered to be in proximity to a selected range of cells.

In some embodiments, one or more prominence rules are applied to the quick analysis tool entry button to define how prominently the quick analysis tool entry button is shown. In some embodiments, a prominence rule instructs the spreadsheet application 108 to show the quick analysis tool entry button as a static button. In some embodiments, a prominence rule instructs the spreadsheet application 108 to change the opacity of the quick analysis tool entry button in relationship to mouse or other input (e.g., touch) proximity to that button. For example, when a cursor controlled by a mouse or other input device is within a specified distance from the quick analysis tool entry button, the quick analysis tool entry button is presented as being 100% opaque, but as the cursor moves away from the button, it becomes translucent, and at some point vanishes from view.

In some embodiments, a prominence rule instructs the spreadsheet application 108 to show the quick analysis tool entry button on mouse over, when touched via a touchscreen interface, or when otherwise interacted with by a user through voice or some other user input. In some embodiments, a prominence rule instructs the spreadsheet application 108 to show the quick analysis tool entry button for a predetermined time period, the expiration of which causes the quick analysis tool entry button to disappear, or to be reconfigured to, for example, appear on mouse over or via some other user input.

In some embodiments, a prominence rule instructs the spreadsheet application 108 to show the quick analysis tool entry button with emphasis to draw a user's attention to the quick analysis tool entry button. In embodiments in which the quick analysis tool entry button includes text, illustrative emphasis types include, but are not limited to, font type, font size, boldface, italics, underline, overline, capitalization, letter spacing, punctuation, color, combinations thereof, and the like. In embodiments in which the quick analysis tool entry button includes a graphic, icon, picture, or symbol, illustrative emphasis types include, but are not limited to, size, color, contrast, brightness, gray scale, special effects, animations, combinations thereof, and the like. In embodiments in which the quick analysis tool entry button includes a video, illustrative emphasis types include, but are not limited to, auto-play, auto-enlarge, auto-fullscreen, and the like. Other emphasis types are contemplated.

In some embodiments, a prominence rule instructs the spreadsheet application 108 to show the quick analysis tool entry button for a predetermined number of times. In some embodiments, a prominence rule instructs the spreadsheet application 108 to show the quick analysis tool entry button for a predetermined number of times, each time decreasing the prominence with which the quick analysis tool entry button is shown until the prominence reaches a default prominence state.

From operation 206, the method 200 proceeds to operation 208, wherein the spreadsheet application 108 determines if the range selection is the first range selection after the spreadsheet application 108 was launched. If the spreadsheet application 108 determines the range selection is the first range selection after the spreadsheet application 108 was launched, the method 200 proceeds to operation 210, wherein a tooltip for the quick analysis tool 116 is shown. In some embodiments, the tooltip includes text and/or pictures or other images to explain one or more aspects of the quick analysis tool 116. In some embodiments, the tooltip overlays at least a portion of an active spreadsheet document displayed by the spreadsheet application 108. In some embodiments, the tooltip is shown in the foreground and any user interface elements that are not associated with the tooltip are shown in the background. In these embodiments, the user interface elements in the background may be modified so as to be less visible to a user than the tooltip in the foreground. For example, the background may be blurred and/or darkened.

In some embodiments, the tooltip is displayed for a finite duration. In some embodiments, the tooltip is displayed automatically without the spreadsheet application 108 making the determination at operation 208, described above. In some embodiments, operation 208 is repeated for a predetermined number of spreadsheet application launches, after which the tooltip is no longer shown. In some embodiments, the tooltip is no longer shown only when the user is making a selection, but may be shown on mouse hover. In some embodiments, whether the tooltip is shown is user-configurable via an option provided by the spreadsheet application 108 in a preferences menu or by way of some other user interface element.

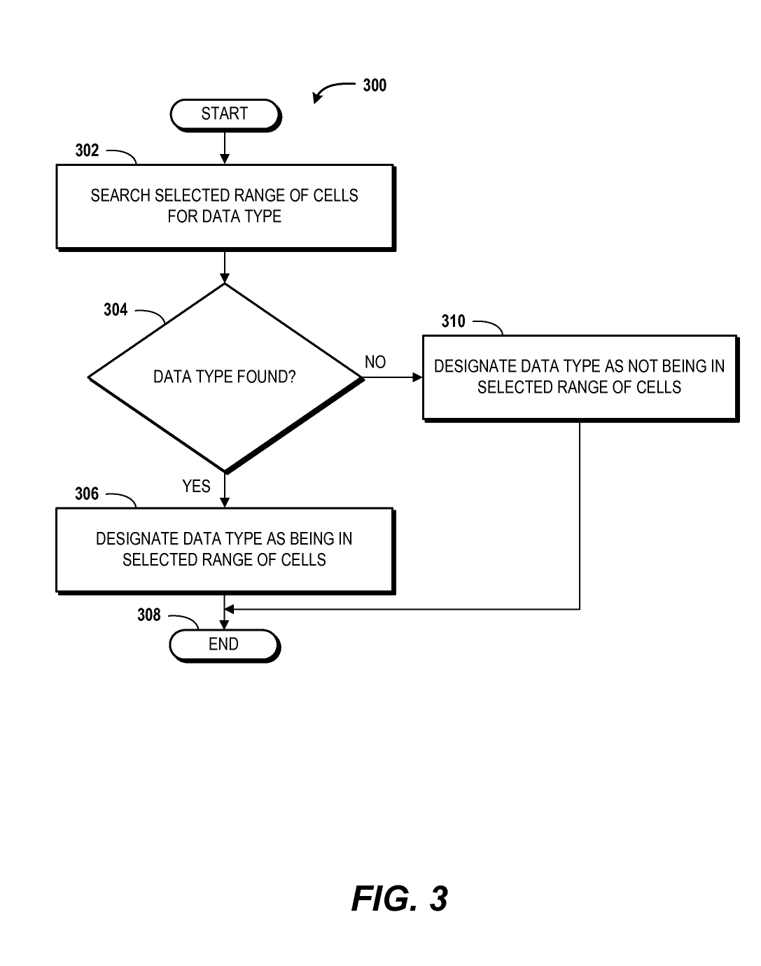

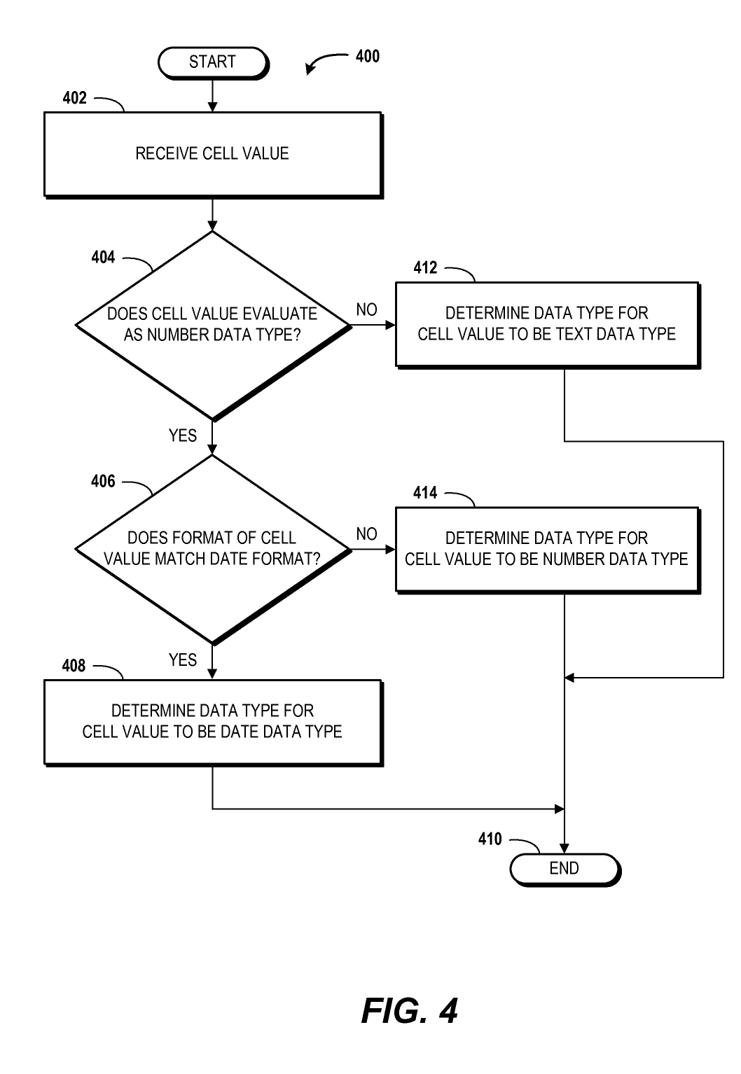

From operation 210, or if the spreadsheet application 108 determines, at operation 208, the range selection is not the first range selection after the spreadsheet application 108 was launched, the method 200 proceeds to FIG. 2B and, particularly, operation 212. At operation 212, the spreadsheet application 108 determines one or more data types of the data within the selected range of cells. An illustrative method 300 for searching a selected range of cells for data types is described herein below with reference to FIG. 3. An illustrative method 400 for determining data types for cell values within a selected range of cells is describe herein below with reference to FIG. 4.

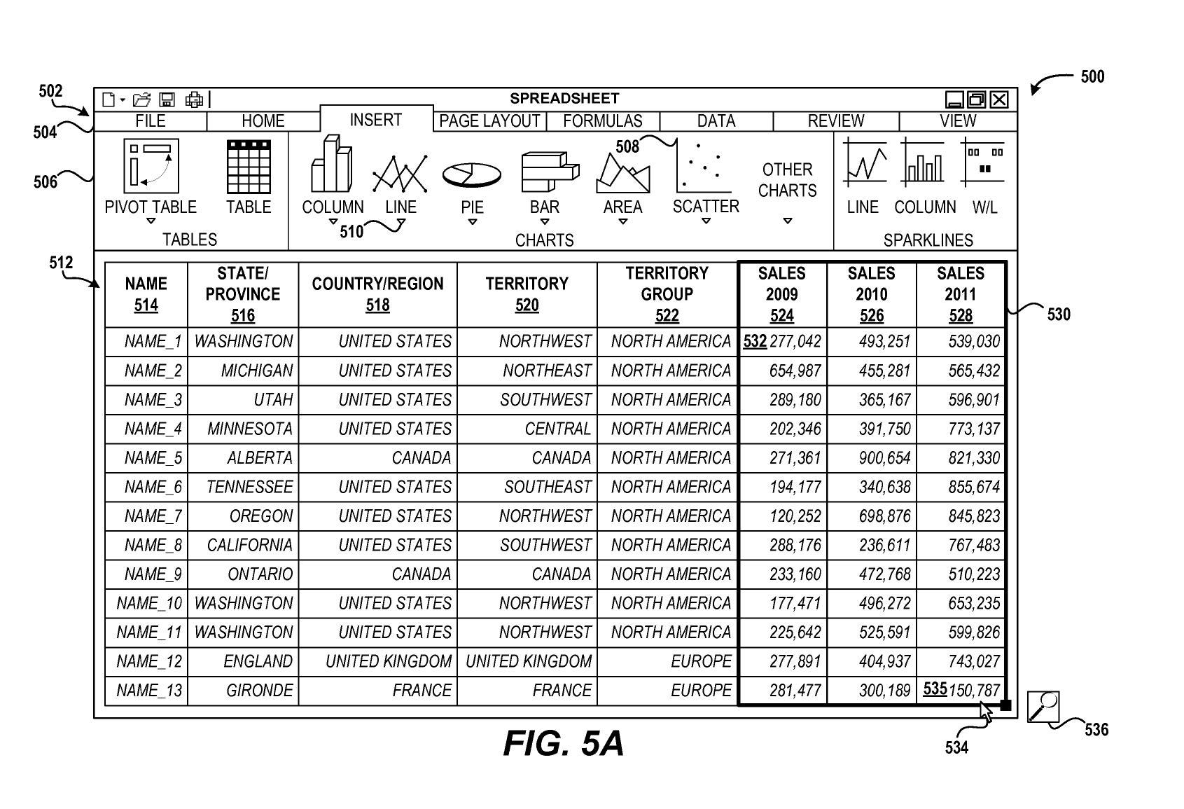

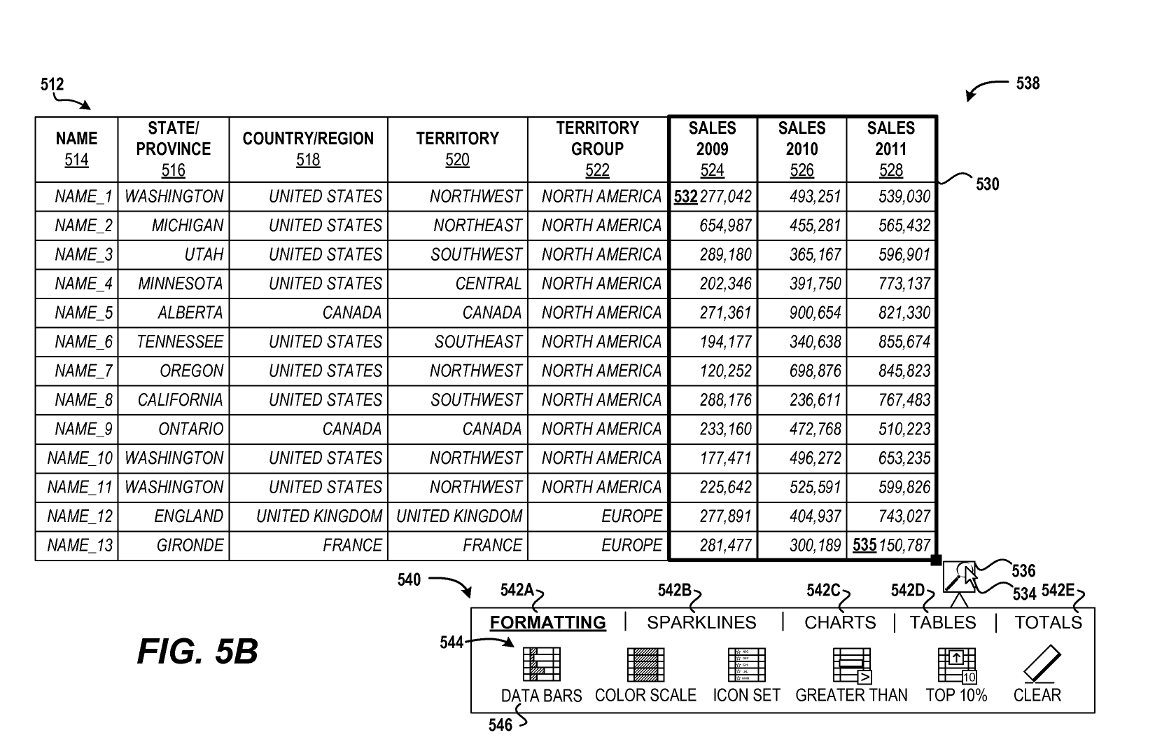

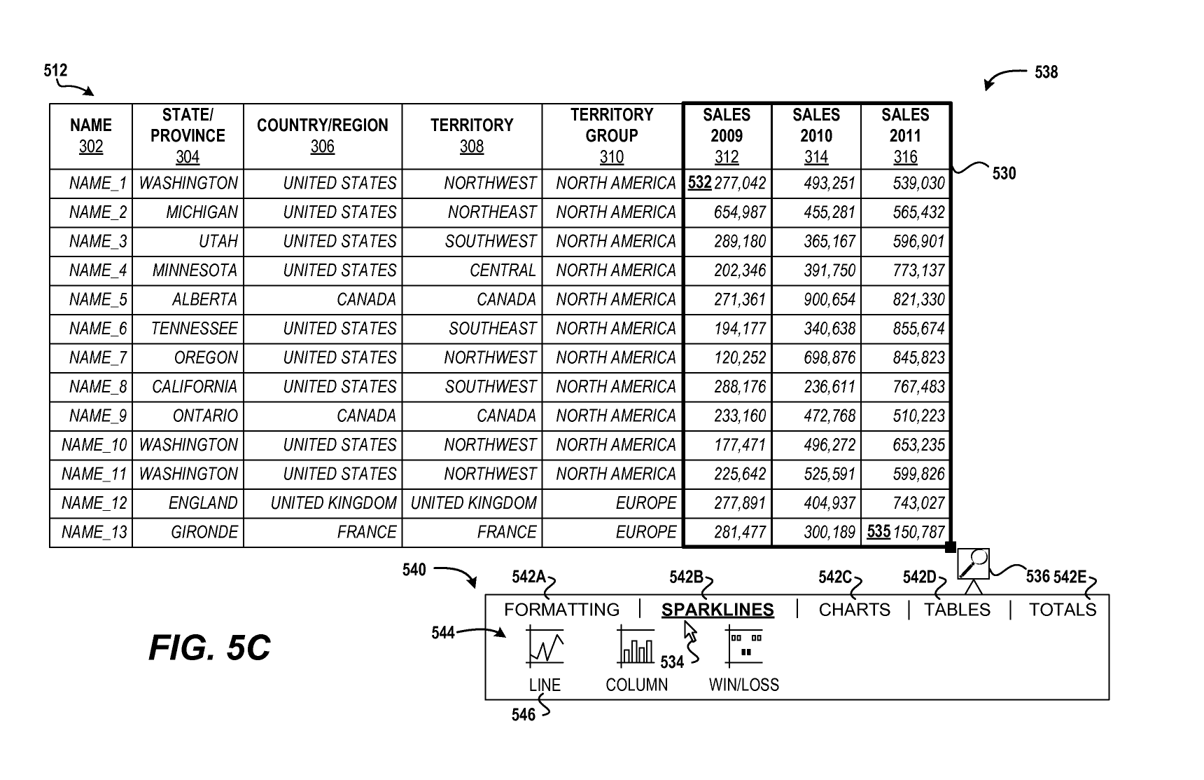

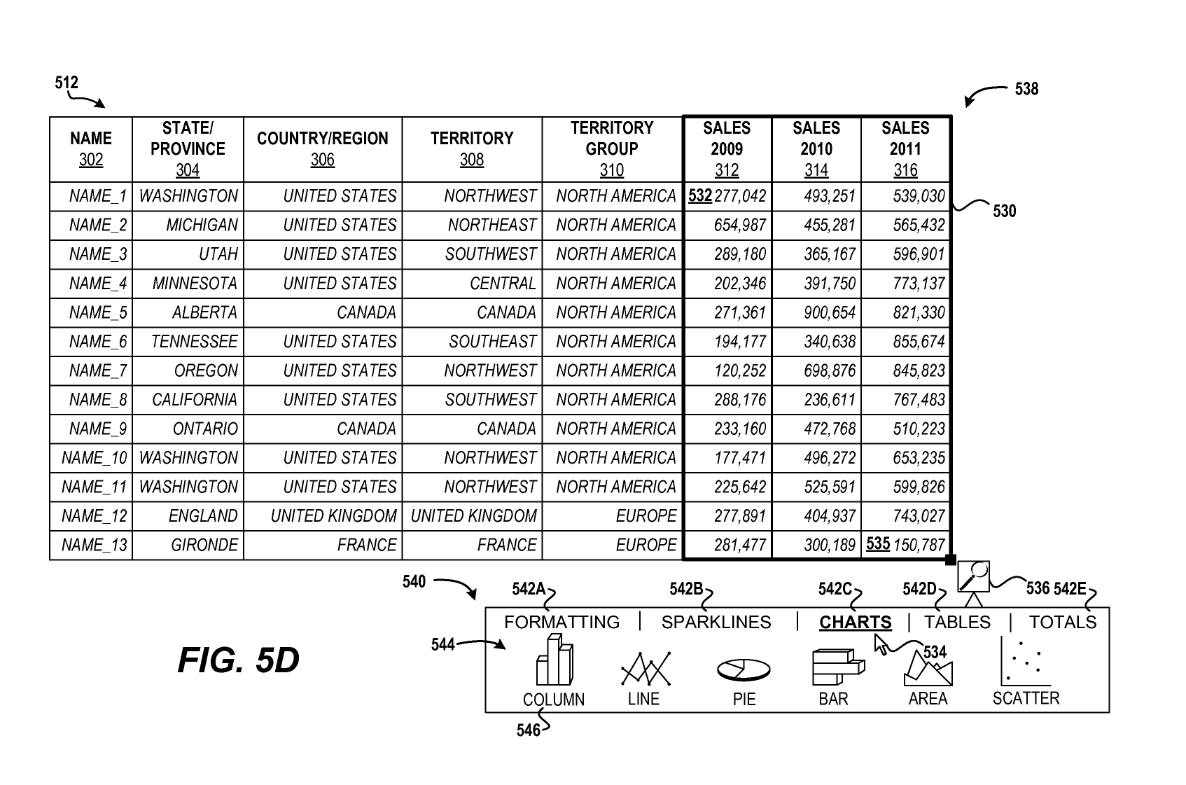

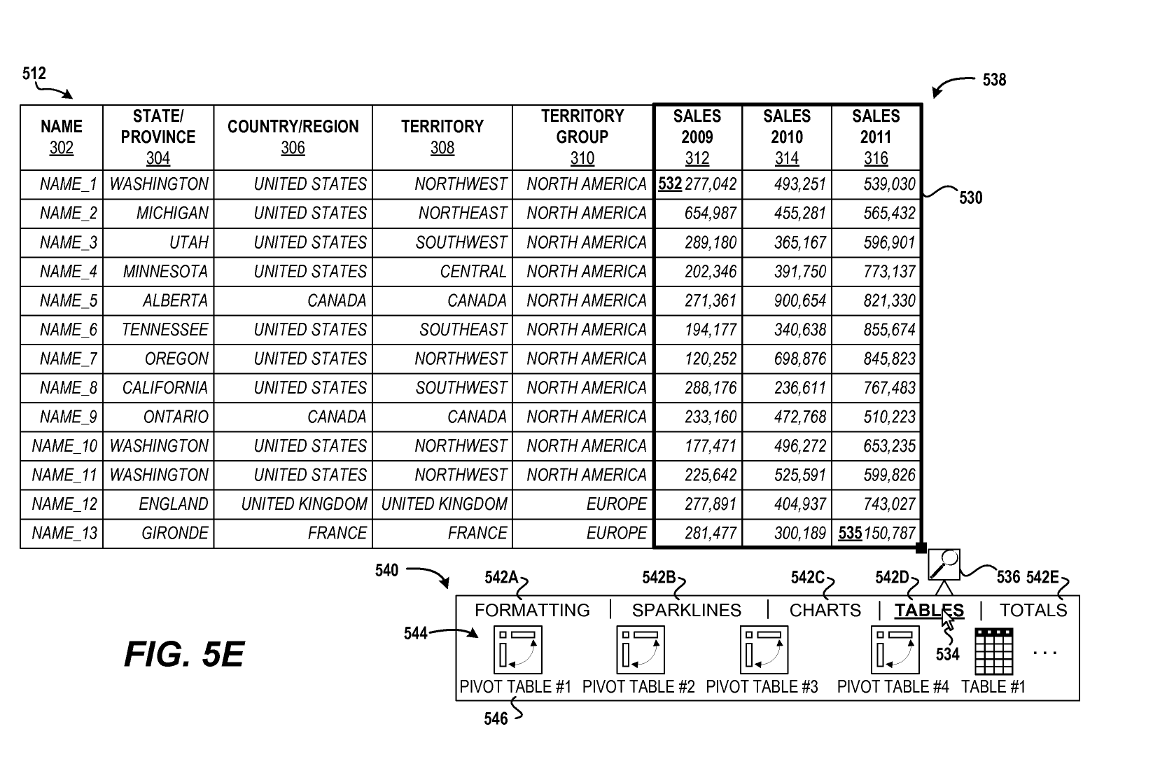

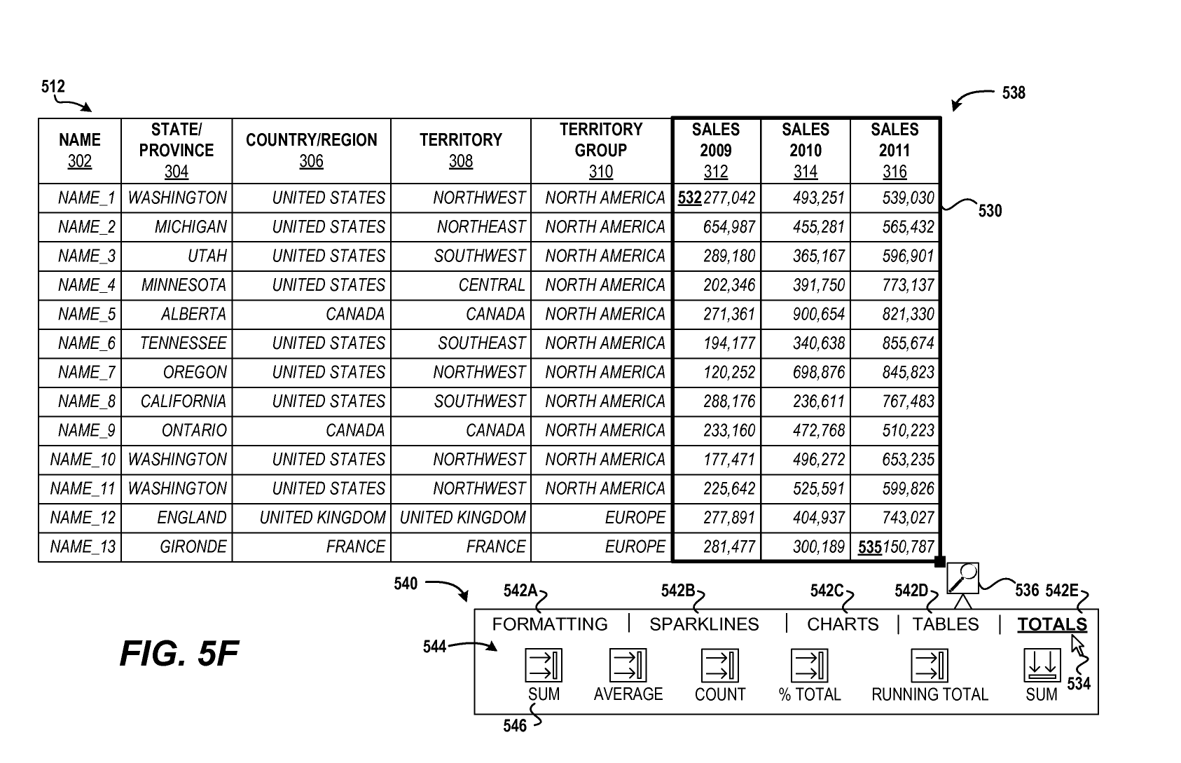

From operation 212, the method 200 proceeds to operation 214, wherein one or more data analysis features that are suitable for application to the data types determined at operation 212 are determined. In some embodiments, the determination at operation 214 is performed at least in part by one or more of the recommendation engines 118 by executing one or more recommendation algorithms, as described above. From operation 214, the method 200 proceeds to operation 216, wherein the spreadsheet application 108 receives a selection of the quick analysis tool entry button. In response to receiving a selection of the quick analysis tool entry button, the method 200 proceeds to operation 218, wherein a user interface for the quick analysis tool 116 is displayed. Various illustrative user interfaces for the quick analysis tool 116 are illustrated and described herein below with reference to FIGS. 5B-5F, 6, and 7.

From operation 218, the method 200 proceeds to operation 220, wherein the spreadsheet application 108 receives a hover, a gesture, or other non-selection focus on a feature from user interface of the quick analysis tool 116. The method 200 then proceeds to operation 222, wherein a preview of the feature is displayed to the user to show the user how the feature would affect the data in the selected range of cells without the feature actually being applied to the data in the selected range of cells.

In some embodiments, the preview temporarily applies the feature to the data in the selected range of cells within the worksheet from which the range of cells was selected. This is referred to herein as an “in grid” preview. Alternatively, in some embodiments, the preview temporarily applies the feature to the data in the selected range of cells in one or more pop-up windows. This is referred herein to as a “pop-up” preview.

In some embodiments, the type of preview used for a feature type or particular feature is selected by a developer of the spreadsheet application 108 based upon the functionality for that feature type or feature. For example, features that create objects within other worksheets, such as a pivot table, would be better suited for a pop-up preview since navigating to a new worksheet to display the object may be confusing or disorienting to the user. In some embodiments, the in grid preview is used for conditional formatting, sparklines, and totals, whereas the pop-up preview is used for tables, pivot tables, and charts. In some embodiments, whether a feature type or particular feature is previewed in grid or via a pop-up window is configurable by the user, such as via a preference option in a menu.

From operation 222, the method 200 proceeds to operation 224, wherein the spreadsheet application 108 receives a selection of a feature via the user interface of the quick analysis tool 116. The method 200 then proceeds to operation 226, wherein the feature selected in operation 224 is applied the data in the selected range of cells. The method 200 then proceeds to operation 228. The method 200 ends at operation 228.

Returning to FIG. 2A, if the spreadsheet application 108 determines, at operation 204, that a range cells has not been selected, the method 200 proceeds to FIG. 2B and, particularly, to operation 228. The method 200 ends at operation 228.

Turning to FIG. 3, a method 300 for searching a selected range of cells for data types will be described, according to an illustrative embodiment. The method 300 begins and proceeds to operation 302, wherein the spreadsheet application 108 searches the selected range of cells for a particular data type. It is contemplated that the method 300 repeats for a plurality of data types. Illustrative data types include text, number, and date, although the method 300 is equally applicable to other data types.

From operation 302, the method 300 proceeds to operation 304, wherein the spreadsheet application 108 determines if the data type upon which the search is based has been found in any of the cells included in the range of cells. If the spreadsheet application 108 determines, at operation 304, that the data type has been found, the method 300 proceeds to operation 306, wherein the data type is designated as being in the selected range of cells. In some embodiments, the data type is designated as being in the selected range of cells by a TRUE operator. The method 300 then proceeds to operation 308. The method 300 ends at operation 308.

If the spreadsheet application 108 determines, at operation 304, that the data type has not been found, the method 300 proceeds to operation 310, wherein the data type is designated as not being in the selected range of cells. In some embodiments, the data type is designated as being in the selected range of cells by a FALSE operator. The method 300 then proceeds to operation 308, wherein the method 300 ends.

Turning now to FIG. 4, a method 400 for determining data types for cell values within a selected range of cells will be described, according to an illustrative embodiment. The method 400 begins and proceeds to operation 402, wherein the spreadsheet application 108 receives a cell value. It is contemplated that the cell values for a given selected range of cells may be processed according to method 400 sequentially or simultaneously. Moreover, the method 400 may be processed as part of the search operations 302, 304 described above with reference to FIG. 3.

From operation 402, the method 400 proceeds to operation 404, wherein the spreadsheet application 108 determines if the cell value evaluates as a number type. If the spreadsheet application 108 determines that the cell value evaluates as a number type, the method 400 proceeds to operation 406, wherein the spreadsheet application 108 determines if the format of the cell value matches a date format, such mm/dd/yy or some other date format. If the spreadsheet application 108 determines, at operation 406, that the cell value matches a date format, the method 400 proceeds to operation 408, wherein the spreadsheet application 108 determines the data type for the cell value to be a date data type. The method 400 then proceeds to operation 410. The method 400 ends at operation 410.

If the spreadsheet application 108 determines, at operation 404, that the cell value does not evaluate as a number data type, the method 400 proceeds to operation 412, wherein the spreadsheet application 108 determines the data type for the cell value to be a text data type. The method 400 then proceeds to operation 410.

The method 400 ends at operation 410.

If the spreadsheet application 108 determines, at operation 406, that the cell value does not match a date format, the method 400 proceeds to operation 414, wherein the spreadsheet application 108 determines the data type for the cell value to be a number data type. The method 400 then proceeds to operation 410. The method 400 ends at operation 410.

It is contemplated that the method 400 can be modified to incorporate other data types. As such, the number data type, the text data type, and the date data type are provided as examples of suitable data types are not intended to limit the data types applicable that may be used as the basis for a determination of one or more data analysis features that are suitable for application thereto.

Turning now to FIGS. 5A-5F, user interface diagrams illustrating aspects of a user interface of a quick analysis tool, such as the quick analysis tool 116, will be described, according to various illustrative embodiments. Referring first to FIG. 5A, an illustrative user interface 500 provided by a spreadsheet application program, such as the spreadsheet application 108, is shown, according to one implementation disclosed herein. The illustrated user interface 500 includes a ribbon interface 502. The ribbon interface 502 is a user interface including a set of toolbars that are placed on tabs in a tab bar 504. In the illustrated embodiment, the tab bar 504 of the ribbon interface 502 includes tabs for FILE, HOME, INSERT, PAGE LAYOUT, FORMULAS, DATA, REVIEW, and VIEW. Also in the illustrated embodiment, the INSERT TAB has been selected and various toolbars associated with tables, charts, and sparklines are shown in a ribbon interface body 506. The illustrated toolbars in the ribbon interface body 506 each include a representative icon 508 for the type of feature provided by the toolbar. Some of the toolbars include an expand button 510, the selection of which causes various available column charts to be displayed to the user. Alternative and/or additional tabs are contemplated and may vary based upon the type of tasks being performed by a user within the spreadsheet application 108. The ribbon interface 502 may be customized by a user to include particular tabs and/or toolbars within tabs.

The illustrated user interface 500 also includes a worksheet 512. The worksheet 512 includes a plurality of rows and columns and sample data. In some embodiments, the worksheet 512 is part of spreadsheet document that includes one or more worksheets. The illustrated worksheet 512 includes eight columns, each labeled as a different category of data. In particular, the illustrated worksheet 512 includes a name column 514, a state/province column 516, a country/region column 518, a territory column 520, a territory group column 522, a sales 2009 column 524, a sales 2010 column 526, and a sales 2011 column 528. The data included in each of the columns 514-528 is for purposes of illustration and is not intended to be limiting in any way. The worksheet 512 is not limited to the number of rows and columns shown in the illustrated embodiment. Moreover, the worksheet 512 need not be populated with data in every cell.

In the illustrated embodiment, a portion 530 of the worksheet 512 has been selected. The selected portion 530 is illustrated as having been created by a user selecting a cell 532 within the worksheet 512, holding the mouse button down or otherwise maintaining the selection, and dragging a mouse cursor 534 down and across to another cell 535 to select the portion 530. Although the illustrated embodiment focuses on the selection of a plurality of cells within the worksheet 512 via a mouse input, other inputs may be used to select one or more cells within the worksheet 512, including, but not limited to, touch input, voice input, keyboard input, combinations thereof, and the like.

The illustrated user interface 500 also includes a quick analysis tool entry button 536. The quick analysis tool entry button 536 is illustrated as a magnifying glass icon, but this icon is not intended to be limiting in any way. The quick analysis tool entry button 536 may be configured in alternative forms such as described above. The appearance of the quick analysis tool entry button 536 may be determined based upon one or more prominence rules as also described above.

Turning now to FIG. 5B, a simplified user interface 538 will be described, according to an illustrative embodiment. The simplified user interface 538 includes the worksheet 512, the selected portion 530, the mouse cursor 534, and the quick analysis tool entry button 536 as described above. In the illustrated embodiment, the mouse cursor 534 is intersecting the quick analysis tool entry button 536. This may be indicative of a mouse click or a mouse over. In the illustrated embodiment, it is assumed that the quick analysis tool entry button 536 has been clicked via a mouse or otherwise selected and, in response thereto, a quick analysis tool user interface 540 is displayed.

The quick analysis tool user interface 540 includes a plurality of tabs 542A-542E. In some embodiments, however, a non-tabbed interface is used. In the illustrated embodiment, a conditional formatting tab 542A has been selected and a gallery 544 is shown in response thereto. The gallery 544 is configured to show one or more representations 546 of one or more features suitable for application to the data included in the selected portion 530. Although the representations 546 are shown as icons and text, the representations 546 may alternatively include icons, text, or some other visual representation to identify the one or more features. In some embodiments, one or more of the representations 546 are the same as the representations used elsewhere in the spreadsheet application 108 for a particular feature. In other embodiments, a simplified or otherwise less intimidating icon, text, or other visual representations are used in lieu of the representations used elsewhere in the spreadsheet application 108 for a particular feature. In some embodiments, additional information about a feature is shown in response to a mouse over or other indication that the user is interested in finding out more information about a particular feature. In touch interfaces, for example, a tap and hold gesture may be used to trigger the additional information to be shown.

In the illustrated embodiment, the conditional formatting tab 542A includes representations 546 for a data bars feature, a color scale feature, an icon set feature, a greater than feature, a top ten percent feature, and a clear feature. The inclusion of the illustrated features in the conditional formatting tab 542A is based upon a determination made by one or more recommendation engines, such as the recommendation engines 118, based upon the data type(s) of the data included in the selected portion 530. The illustrated features are used merely for purposes of illustration and are not intended to be limiting in any way. The particular functionality provided by these illustrated features is beyond the scope of this disclosure. Those skilled in the art will appreciate the applicability of additional and/or alternative features to the conditional formatting tab 542A.

Turning now to FIG. 5C, the quick analysis tool user interface 540 is shown with the sparklines tab 542B selected. In the illustrated embodiment, the sparklines tab 542B includes representations 546 for a line sparklines feature, a column sparklines feature, and a win/loss sparklines feature. The inclusion of the illustrated features in the sparklines tab 542B is based upon a determination made by one or more recommendation engines, such as the recommendation engines 118, based upon the data type(s) of the data included in the selected portion 530. The illustrated features are used merely for purposes of illustration and are not intended to be limiting in any way. The particular functionality provided by these illustrated features is beyond the scope of this disclosure. Those skilled in the art will appreciate the applicability of additional and/or alternative features to the sparklines tab 542B.

Turning now to FIG. 5D, the quick analysis tool user interface 540 is shown with the charts tab 542C selected. In the illustrated embodiment, the charts tab 542C includes representations 546 for a column chart feature, a line chart feature, a pie chart feature, a bar chart feature, an area chart feature, and a scatter chart feature.

The inclusion of the illustrated features in the charts tab 542C is based upon a determination made by one or more recommendation engines, such as the recommendation engines 118, based upon the data type(s) of the data included in the selected portion 530. The illustrated features are used merely for purposes of illustration and are not intended to be limiting in any way. The particular functionality provided by these illustrated features is beyond the scope of this disclosure. Those skilled in the art will appreciate the applicability of additional and/or alternative features to the charts tab 542C.

Turning now to FIG. 5E, the quick analysis tool user interface 540 is shown with the tables tab 542D selected. In the illustrated embodiment, the tables tab 542D includes representations 546 for pivot table features and table features. The inclusion of the illustrated features in the tables tab 542D is based upon a determination made by one or more recommendation engines, such as the recommendation engines 118, based upon the data type(s) of the data included in the selected portion 530. The illustrated features are used merely for purposes of illustration and are not intended to be limiting in any way. The particular functionality provided by these illustrated features is beyond the scope of this disclosure. Those skilled in the art will appreciate the applicability of additional and/or alternative features to the tables tab 542D.

Turning now to FIG. 5F, the quick analysis tool user interface 540 is shown with the totals tab 542E selected. In the illustrated embodiment, the totals tab 542E includes representations 546 for a column sum feature, a column average feature, a column percentage total feature, a column running total feature, and a row sum feature. The inclusion of the illustrated features in the totals tab 542E is based upon a determination made by one or more recommendation engines, such as the recommendation engines 118, based upon the data type(s) of the data included in the selected portion 530. The illustrated features are used merely for purposes of illustration and are not intended to be limiting in any way. The particular functionality provided by these illustrated features is beyond the scope of this disclosure. Those skilled in the art will appreciate the applicability of additional and/or alternative features to the totals tab 542E.

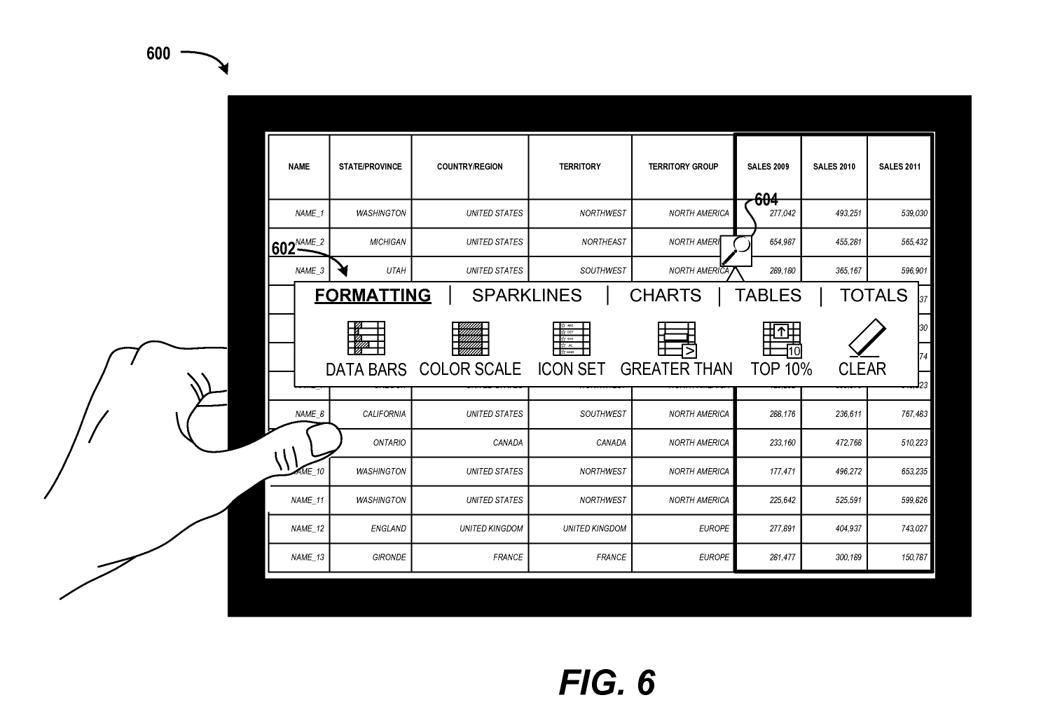

Turning now to FIG. 6, an illustrative tablet device 600 with a touch-enabled quick analysis tool user interface 602 is shown. The tablet device 600 may utilize all or a portion of the computing device architecture described herein below with reference to FIG. 10. In the illustrated embodiment, the touch-enabled quick analysis tool user interface 602 is triggered by a selection of a touch-enabled quick analysis tool entry button 604 via a single or multi-touch gesture. The functionality of the touch-enabled quick analysis tool user interface 602 and the touch-enabled quick analysis tool entry button 604 may be similar to the functionality described above for the quick analysis tool user interface 540 and the quick analysis tool entry button 536, respectively.

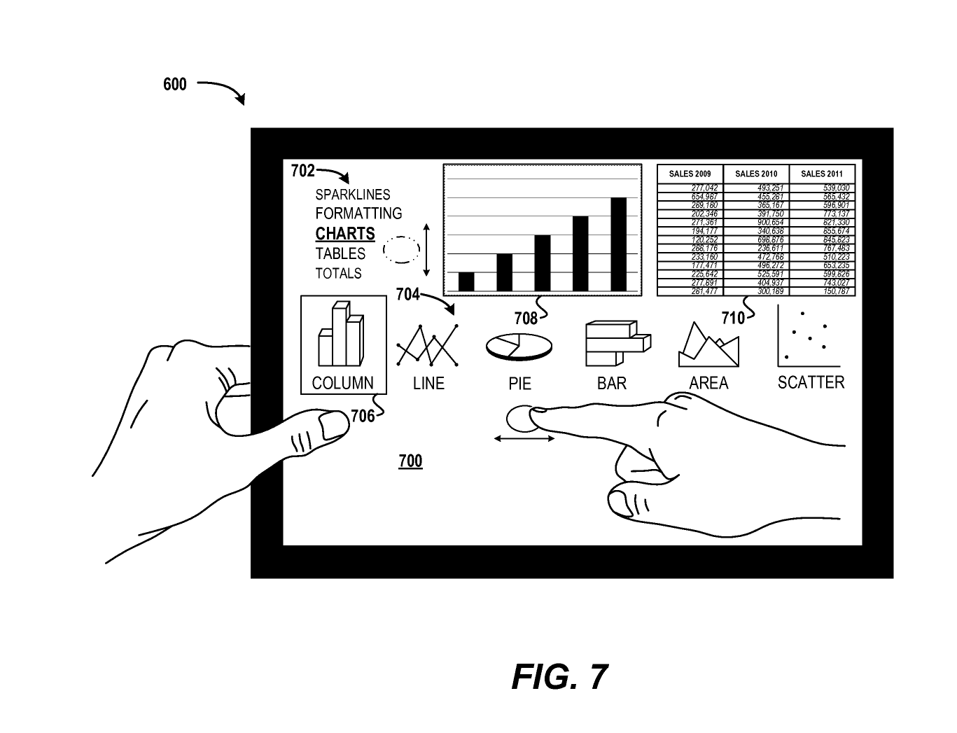

Turning now to FIG. 7, the tablet device 600 is shown with an alternative touch-enabled quick analysis tool user interface 700. The alternative touch-enabled quick analysis tool user interface 700 includes a vertical selection menu 702, a gallery 704, a gallery selection 706, a live preview 708, and a selected portion 710. The vertical selection menu 702 is configured to respond to vertical swipe gestures and taps for the selection of a feature category. The illustrated feature categories are the same the feature tabs 542A-542E described above. The selection of one of the feature categories from the vertical selection menu 702 causes the gallery 704 including representations of features within the selected categories to be shown. In the illustrated embodiment, the charts category has been selected and, in response thereto, the gallery 704 includes representation of various chart features.

The gallery selection 706 indicates that the user has selected a column chart feature from the gallery 704. In the illustrated embodiment, the live preview 708 shows the selected portion 710 of data from a worksheet in a column chart in accordance with gallery selection 706. It is contemplated that a user can tap or use a touch gesture on the live preview 708 to zoom-in for a closer view of the chart or other information displayed within the live preview 708. In some embodiments, selection of the live preview 708 causes the information contained within to be enlarged. In some embodiments, the information contained with the live preview 708 is enlarged to full screen. It is also contemplated that a user can interact with the selected portion 710 in a similar manner. Enlarging the selected portion 710 may provide additional context including, for example, one or more cells that surround the selected portion 710 within a worksheet from which the selected portion 710 was selected. In some embodiments, touching the selected portion 710 returns the user to a touch-enabled user interface that is visually similar or identical the user interface 500, or the simplified user interface 538 described herein above.

FIG. 8 illustrates an illustrative computer architecture 800 for a device capable of executing the software components described herein for utilizing a quick analysis tool to advertise data analysis features of a spreadsheet application based upon a selection of a range of cells within a spreadsheet document, among other aspects. Thus, the computer architecture 800 illustrated in FIG. 8 illustrates an architecture for a server computer, mobile phone, a PDA, a smart phone, a desktop computer, a netbook computer, a tablet computer, and/or a laptop computer. The computer architecture 800 may be utilized to execute any aspects of the software components presented herein.

In some embodiments, the client computer 102 and/or the server computer 114 are configured in accordance with the computer architecture 800. As such, software components of the client computer 102 and the server computer 114 are shown together within the computer architecture 800 for ease of illustration. It should be understood, however, that these software components may be and are likely to be implemented in separate client and server computers in a client/server configuration, or as standalone software components executing on one or both of the client computer 102 and the server computer 114.

The computer architecture 800 illustrated in FIG. 8 includes a central processing unit 802 (“CPU”), a system memory 804, including a random access memory 806 (“RAM”) and a read-only memory (“ROM”) 808, and a system bus 810 that couples the memory 804 to the CPU 802. A basic input/output system containing the basic routines that help to transfer information between elements within the computer architecture 800, such as during startup, is stored in the ROM 808. The computer architecture 800 further includes a mass storage device 812 for storing the operating system 106 and the server operating system 120, and one or more application programs including, but not limited to, the spreadsheet application program 108, the server spreadsheet application program 122, and the web browser application 110. The illustrated mass storage device 812 also stores the quick analysis tool 116, the server quick analysis tool 126, the recommendation engine(s) 118, and the server recommendation engine(s) 128.

The mass storage device 812 is connected to the CPU 802 through a mass storage controller (not shown) connected to the bus 810. The mass storage device 812 and its associated computer-readable media provide non-volatile storage for the computer architecture 800. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 800. For purposes the claims, the phrase “computer storage medium” and variations thereof, does not include waves, signals, and/or other transitory and/or intangible communication media, per se.

According to various embodiments, the computer architecture 800 may operate in a networked environment using logical connections to remote computers through the network 104 and/or another network (not shown). The computer architecture 800 may connect to the network 104 through a network interface unit 814 connected to the bus 810. It should be appreciated that the network interface unit 814 also may be utilized to connect to other types of networks and remote computer systems. The computer architecture 800 also may include an input/output controller 816 for receiving and processing input from a number of other devices, including a keyboard, mouse, or electronic stylus (not shown in FIG. 8). Similarly, the input/output controller 816 may provide output to a display screen, a printer, or other type of output device (also not shown in FIG. 8).

It should be appreciated that the software components described herein may, when loaded into the CPU 802 and executed, transform the CPU 802 and the overall computer architecture 800 from a general-purpose computing system into a special-purpose computing system customized to facilitate the functionality presented herein. The CPU 802 may be constructed from any number of transistors or other discrete circuit elements, which may individually or collectively assume any number of states. More specifically, the CPU 802 may operate as a finite-state machine, in response to executable instructions contained within the software modules disclosed herein. These computer-executable instructions may transform the CPU 802 by specifying how the CPU 802 transitions between states, thereby transforming the transistors or other discrete hardware elements constituting the CPU 802.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 800 in order to store and execute the software components presented herein. It also should be appreciated that the computer architecture 800 may include other types of computing devices, including hand-held computers, embedded computer systems, personal digital assistants, and other types of computing devices known to those skilled in the art. It is also contemplated that the computer architecture 800 may not include all of the components shown in FIG. 8, may include other components that are not explicitly shown in FIG. 8, or may utilize an architecture completely different than that shown in FIG. 8.

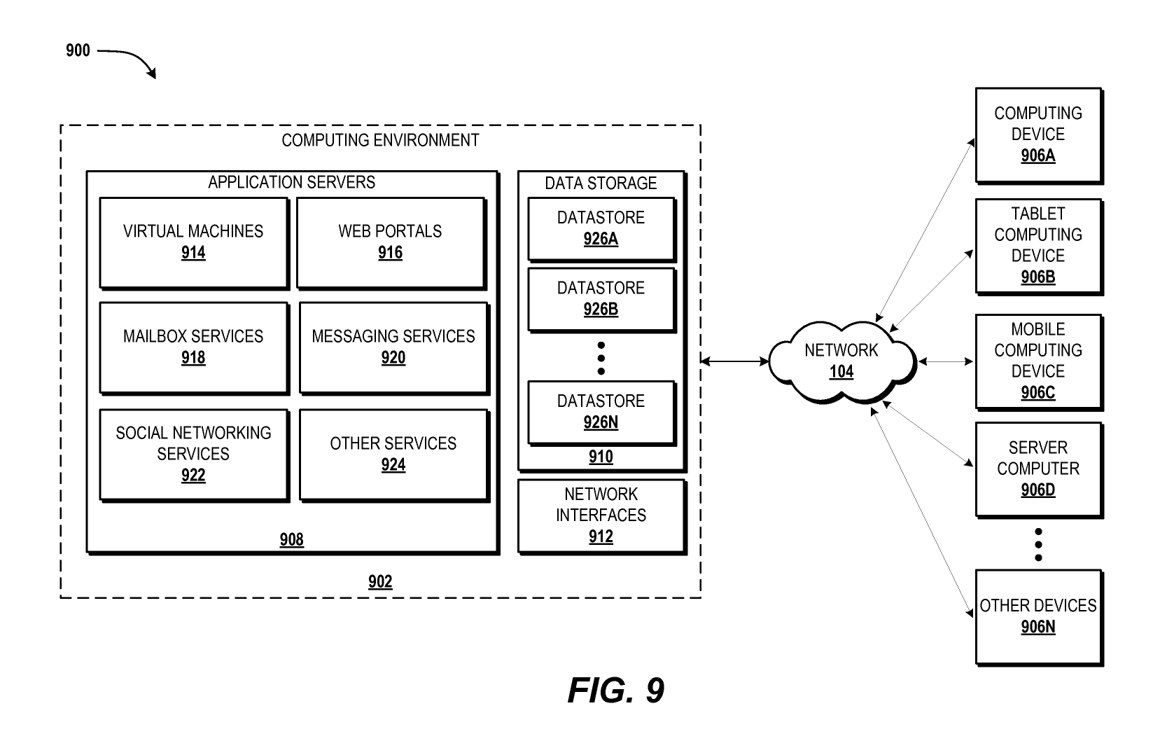

FIG. 9 illustrates an illustrative distributed computing environment 900 capable of executing the software components described herein for utilizing a quick analysis tool to advertise data analysis features of a spreadsheet application based upon a selection of a range of cells within a spreadsheet document, among other aspects. Thus, the distributed computing environment 900 illustrated in FIG. 9 can be utilized to execute any aspects of the software components presented herein. For example, the distributed computing environment 900 can be utilized to execute aspects of the spreadsheet application 108, the server spreadsheet application 122, the quick analysis tool 116, the server quick analysis tool 126, the recommendation engine(s) 118, the server recommendation engine(s) 128, and/or other software components described herein.

According to various implementations, the distributed computing environment 900 includes a computing environment 902 operating on, in communication with, or as part of the network 904. The network 904 may be or may include the network 104, described above with reference to FIG. 1. The network 904 also can include various access networks. One or more client devices 906A-906N (hereinafter referred to collectively and/or generically as “clients 906”) can communicate with the computing environment 902 via the network 904 and/or other connections (not illustrated in FIG. 9). In the illustrated embodiment, the clients 906 include a computing device 906A such as a laptop computer, a desktop computer, or other computing device; a slate or tablet computing device (“tablet computing device”) 906B; a mobile computing device 906C such as a mobile telephone, a smart phone, or other mobile computing device; a server computer 906D; and/or other devices 906N. It should be understood that any number of clients 906 can communicate with the computing environment 902. Two example computing architectures for the clients 906 are illustrated and described herein with reference to FIGS. 8 and 10. It should be understood that the illustrated clients 906 and computing architectures illustrated and described herein are illustrative, and should not be construed as being limited in any way.

In the illustrated embodiment, the computing environment 902 includes application servers 908, data storage 910, and one or more network interfaces 912. According to various implementations, the functionality of the application servers 908 can be provided by one or more server computers that are executing as part of, or in communication with, the network 904. The application servers 908 can host various services, virtual machines, portals, and/or other resources. In the illustrated embodiment, the application servers 908 host one or more virtual machines 914 for hosting applications or other functionality. According to various implementations, the virtual machines 914 host one or more applications and/or software modules for providing the functionality described herein for utilizing a quick analysis tool to advertise data analysis features of a spreadsheet application based upon a selection of a range of cells within a spreadsheet document, among other aspects. It should be understood that this embodiment is illustrative, and should not be construed as being limiting in any way. The application servers 908 also host or provide access to one or more Web portals, link pages, Web sites, and/or other information (“Web portals”) 916.

According to various implementations, the application servers 908 also include one or more mailbox services 918 and one or more messaging services 920. The mailbox services 918 can include electronic mail (“email”) services. The mailbox services 918 also can include various personal information management (“PIM”) services including, but not limited to, calendar services, contact management services, collaboration services, and/or other services. The messaging services 920 can include, but are not limited to, instant messaging services, chat services, forum services, and/or other communication services.

The application servers 908 also can include one or more social networking services 922. The social networking services 922 can include various social networking services including, but not limited to, services for sharing or posting status updates, instant messages, links, photos, videos, and/or other information; services for commenting or displaying interest in articles, products, blogs, or other resources: and/or other services. In some embodiments, the social networking services 922 are provided by or include the FACEBOOK social networking service, the LINKEDIN professional networking service, the MYSPACE social networking service, the FOURSQUARE geographic networking service, the YAMMER office colleague networking service, and the like. In other embodiments, the social networking services 922 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 922 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 922 are not mentioned herein for the sake of brevity. As such, the above embodiments are illustrative, and should not be construed as being limited in any way.

As shown in FIG. 9, the application servers 908 also can host other services, applications, portals, and/or other resources (“other resources”) 924. The other resources 924 can include, but are not limited to, the presentation application program. It thus can be appreciated that the computing environment 902 can provide integration of the concepts and technologies disclosed herein provided herein with various mailbox, messaging, social networking, and/or other services or resources.

As mentioned above, the computing environment 902 can include the data storage 910. According to various implementations, the functionality of the data storage 910 is provided by one or more databases operating on, or in communication with, the network 904. The functionality of the data storage 910 also can be provided by one or more server computers configured to host data for the computing environment 902. The data storage 910 can include, host, or provide one or more real or virtual datastores 926A-926N (hereinafter referred to collectively and/or generically as “datastores 926”). The datastores 926 are configured to host data used or created by the application servers 908 and/or other data. Although not illustrated in FIG. 9, the datastores 926 also can host or store spreadsheet documents, algorithm for execution by a recommendation engine, and/or other data utilized by a spreadsheet application program.

The computing environment 902 can communicate with, or be accessed by, the network interfaces 912. The network interfaces 912 can include various types of network hardware and software for supporting communications between two or more computing devices including, but not limited to, the clients 906 and the application servers 908. It should be appreciated that the network interfaces 912 also may be utilized to connect to other types of networks and/or computer systems.

It should be understood that the distributed computing environment 900 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 900 provides the software functionality described herein as a service to the clients 906. It should be understood that the clients 906 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 900 to utilize the functionality described herein for utilizing a quick analysis tool to advertise data analysis features of a spreadsheet application based upon a selection of a range of cells within a spreadsheet document, among other aspects.

Turning now to FIG. 10, an illustrative computing device architecture 1000 for a computing device that is capable of executing various software components described herein for utilizing a quick analysis tool to advertise data analysis features of a spreadsheet application based upon a selection of a range of cells within a spreadsheet document, among other aspects. The computing device architecture 1000 is applicable to computing devices that facilitate mobile computing due, in part, to form factor, wireless connectivity, and/or battery-powered operation. In some embodiments, the computing devices include, but are not limited to, mobile telephones, tablet devices, slate devices, portable video game devices, and the like. The computing device architecture 1000 is applicable to any of the clients 1306 shown in FIG. 9. Moreover, aspects of the computing device architecture 1000 may be applicable to traditional desktop computers, portable computers (e.g., laptops, notebooks, ultra-portables, and netbooks), server computers, and other computer systems, such as described herein with reference to FIG. 8. For example, the single touch and multi-touch aspects disclosed herein below may be applied to desktop computers that utilize a touchscreen or some other touch-enabled device, such as a touch-enabled track pad or touch-enabled mouse.

The computing device architecture 1000 illustrated in FIG. 10 includes a processor 1002, memory components 1004, network connectivity components 1006, sensor components 1008, input/output components 1010, and power components 1012. In the illustrated embodiment, the processor 1002 is in communication with the memory components 1004, the network connectivity components 1006, the sensor components 1008, the input/output (“I/O”) components 1010, and the power components 1012. Although no connections are shown between the individuals components illustrated in FIG. 10, the components can interact to carry out device functions. In some embodiments, the components are arranged so as to communicate via one or more busses (not shown).

The processor 1002 includes a central processing unit (“CPU”) configured to process data, execute computer-executable instructions of one or more application programs, and communicate with other components of the computing device architecture 1000 in order to perform various functionality described herein. The processor 1002 may be utilized to execute aspects of the software components presented herein and, particularly, those that utilize, at least in part, a touch-enabled input.

In some embodiments, the processor 1002 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some embodiments, the processor 1002 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some embodiments, the processor 1002 is, or is included in, a system-on-chip (“SoC”) along with one or more of the other components described herein below. For example, the SoC may include the processor 1002, a GPU, one or more of the network connectivity components 1006, and one or more of the sensor components 1008. In some embodiments, the processor 1002 is fabricated, in part, utilizing a package-on-package (“PoP”) integrated circuit packaging technique. The processor 1002 may be a single core or multi-core processor.

The processor 1002 may be created in accordance with an ARM architecture, available for license from ARM HOLDINGS of Cambridge, United Kingdom. Alternatively, the processor 1002 may be created in accordance with an x86 architecture, such as is available from INTEL CORPORATION of Mountain View, Calif. and others. In some embodiments, the processor 1002 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 1004 include a random access memory (“RAM”) 1014, a read-only memory (“ROM”) 1016, an integrated storage memory (“integrated storage”) 1018, and a removable storage memory (“removable storage”) 1020. In some embodiments, the RAM 1014 or a portion thereof, the ROM 1018 or a portion thereof, and/or some combination the RAM 1014 and the ROM 1018 is integrated in the processor 1002. In some embodiments, the ROM 1018 is configured to store a firmware, an operating system or a portion thereof (e.g., operating system kernel), and/or a bootloader to load an operating system kernel from the integrated storage 1018 and/or the removable storage 1020.

The integrated storage 1018 can include a solid-state memory, a hard disk, or a combination of solid-state memory and a hard disk. The integrated storage 1018 may be soldered or otherwise connected to a logic board upon which the processor 1002 and other components described herein also may be connected. As such, the integrated storage 1018 is integrated in the computing device. The integrated storage 1018 is configured to store an operating system or portions thereof, application programs, data, and other software components described herein.

The removable storage 1020 can include a solid-state memory, a hard disk, or a combination of solid-state memory and a hard disk. In some embodiments, the removable storage 1020 is provided in lieu of the integrated storage 1018. In other embodiments, the removable storage 1020 is provided as additional optional storage. In some embodiments, the removable storage 1020 is logically combined with the integrated storage 1018 such that the total available storage is made available as a total combined storage capacity. In some embodiments, the total combined capacity of the integrated storage 1018 and the removable storage 1020 is shown to a user instead of separate storage capacities for the integrated storage 1018 and the removable storage 1020.

The removable storage 1020 is configured to be inserted into a removable storage memory slot (not shown) or other mechanism by which the removable storage 1020 is inserted and secured to facilitate a connection over which the removable storage 1020 can communicate with other components of the computing device, such as the processor 1002. The removable storage 1020 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 1004 can store an operating system. According to various embodiments, the operating system includes, but is not limited to, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 1006 include a wireless wide area network component (“WWAN component”) 1022, a wireless local area network component (“WLAN component”) 1024, and a wireless personal area network component (“WPAN component”) 1026. The network connectivity components 1006 facilitate communications to and from the network 104 or another network, which may be a WWAN, a WLAN, or a WPAN. Although only the network 104 is illustrated, the network connectivity components 1006 may facilitate simultaneous communication with multiple networks. For example, the network connectivity components 1006 may facilitate simultaneous communications with multiple networks via one or more of a WWAN, a WLAN, or a WPAN.

The network 104 may be or may include a WWAN, such as a mobile telecommunications network utilizing one or more mobile telecommunications technologies to provide voice and/or data services to a computing device utilizing the computing device architecture 1000 via the WWAN component 1022. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 104 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 104 may be configured to provide voice and/or data communications with any combination of the above technologies. The network 104 may be configured to or adapted to provide voice and/or data communications in accordance with future generation technologies.

In some embodiments, the WWAN component 1022 is configured to provide dual-multi-mode connectivity to the network 104. For example, the WWAN component 1022 may be configured to provide connectivity to the network 104, wherein the network 104 provides service via GSM and UMTS technologies, or via some other combination of technologies. Alternatively, multiple WWAN components 1022 may be utilized to perform such functionality, and/or provide additional functionality to support other non-compatible technologies (i.e., incapable of being supported by a single WWAN component). The WWAN component 1022 may facilitate similar connectivity to multiple networks (e.g., a UMTS network and an LTE network).

The network 104 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some embodiments, the WLAN is implemented utilizing one or more wireless WI-FI access points. In some embodiments, one or more of the wireless WI-FI access points are another computing device with connectivity to a WWAN that are functioning as a WI-FI hotspot. The WLAN component 1024 is configured to connect to the network 104 via the WI-FI access points. Such connections may be secured via various encryption technologies including, but not limited, WI-FI Protected Access (“WPA”), WPA2, Wired Equivalent Privacy (“WEP”), and the like.

The network 104 may be a WPAN operating in accordance with Infrared Data Association (“IrDA”), BLUETOOTH, wireless Universal Serial Bus (“USB”), Z-Wave, ZIGBEE, or some other short-range wireless technology. In some embodiments, the WPAN component 1026 is configured to facilitate communications with other devices, such as peripherals, computers, or other computing devices via the WPAN.

The sensor components 1008 include a magnetometer 1028, an ambient light sensor 1030, a proximity sensor 1032, an accelerometer 1034, a gyroscope 1036, and a Global Positioning System sensor (“GPS sensor”) 1038. It is contemplated that other sensors, such as, but not limited to, temperature sensors or shock detection sensors, also may be incorporated in the computing device architecture 1000.

The magnetometer 1028 is configured to measure the strength and direction of a magnetic field. In some embodiments the magnetometer 1028 provides measurements to a compass application program stored within one of the memory components 1004 in order to provide a user with accurate directions in a frame of reference including the cardinal directions, north, south, east, and west. Similar measurements may be provided to a navigation application program that includes a compass component. Other uses of measurements obtained by the magnetometer 1028 are contemplated.

The ambient light sensor 1030 is configured to measure ambient light. In some embodiments, the ambient light sensor 1030 provides measurements to an application program stored within one the memory components 1004 in order to automatically adjust the brightness of a display (described below) to compensate for low-light and high-light environments. Other uses of measurements obtained by the ambient light sensor 1030 are contemplated.

The proximity sensor 1032 is configured to detect the presence of an object or thing in proximity to the computing device without direct contact. In some embodiments, the proximity sensor 1032 detects the presence of a user's body (e.g., the user's face) and provides this information to an application program stored within one of the memory components 1004 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 1028 are contemplated.

The accelerometer 1034 is configured to measure proper acceleration. In some embodiments, output from the accelerometer 1034 is used by an application program as an input mechanism to control some functionality of the application program. For example, the application program may be a video game in which a character, a portion thereof, or an object is moved or otherwise manipulated in response to input received via the accelerometer 1034. In some embodiments, output from the accelerometer 1034 is provided to an application program for use in switching between landscape and portrait modes, calculating coordinate acceleration, or detecting a fall. Other uses of the accelerometer 1034 are contemplated.

The gyroscope 1036 is configured to measure and maintain orientation. In some embodiments, output from the gyroscope 1036 is used by an application program as an input mechanism to control some functionality of the application program. For example, the gyroscope 1036 can be used for accurate recognition of movement within a 3D environment of a video game application or some other application. In some embodiments, an application program utilizes output from the gyroscope 1036 and the accelerometer 1034 to enhance control of some functionality of the application program. Other uses of the gyroscope 1036 are contemplated.

The GPS sensor 1038 is configured to receive signals from GPS satellites for use in calculating a location. The location calculated by the GPS sensor 1038 may be used by any application program that requires or benefits from location information. For example, the location calculated by the GPS sensor 1038 may be used with a navigation application program to provide directions from the location to a destination or directions from the destination to the location. Moreover, the GPS sensor 1038 may be used to provide location information to an external location-based service, such as E911 service. The GPS sensor 1038 may obtain location information generated via WI-FI, WIMAX, and/or cellular triangulation techniques utilizing one or more of the network connectivity components 1006 to aid the GPS sensor 1038 in obtaining a location fix. The GPS sensor 1038 may also be used in Assisted GPS (“A-GPS”) systems.

The I/O components 1010 include a display 1040, a touchscreen 1042, a data I/O interface component (“data I/O”) 1044, an audio I/O interface component (“audio I/O”) 1046, a video I/O interface component (“video I/O”) 1048, and a camera 1050. In some embodiments, the display 1040 and the touchscreen 1042 are combined. In some embodiments two or more of the data I/O component 1044, the audio I/O component 1046, and the video I/O component 1048 are combined. The I/O components 1010 may include discrete processors configured to support the various interface described below, or may include processing functionality built-in to the processor 1002.

The display 1040 is an output device configured to present information in a visual form. In particular, the display 1040 may present graphical user interface (“GUI”) elements, a quick analysis tool user interface, text, images, video, notifications, virtual buttons, virtual keyboards, messaging data, Internet content, device status, time, date, calendar data, preferences, map information, location information, and any other information that is capable of being presented in a visual form. In some embodiments, the display 1040 is a liquid crystal display (“LCD”) utilizing any active or passive matrix technology and any backlighting technology (if used). In some embodiments, the display 1040 is an organic light emitting diode (“OLED”) display. Other display types are contemplated.

The touchscreen 1042 is an input device configured to detect the presence and location of a touch. The touchscreen 1042 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen 1042 is incorporated on top of the display 1040 as a transparent layer to enable a user to use one or more touches to interact with objects or other information presented on the display 1040. In other embodiments, the touchscreen 1042 is a touch pad incorporated on a surface of the computing device that does not include the display 1040. For example, the computing device may have a touchscreen incorporated on top of the display 1040 and a touch pad on a surface opposite the display 1040.

In some embodiments, the touchscreen 1042 is a single-touch touchscreen. In other embodiments, the touchscreen 1042 is a multi-touch touchscreen. In some embodiments, the touchscreen 1042 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 1042. As such, a developer may create gestures that are specific to a particular application program.

In some embodiments, the touchscreen 1042 supports a tap gesture in which a user taps the touchscreen 1042 once on an item presented on the display 1040. The tap gesture may be used for various reasons including, but not limited to, opening or launching whatever the user taps. In some embodiments, the touchscreen 1042 supports a double tap gesture in which a user taps the touchscreen 1042 twice on an item presented on the display 1040. The double tap gesture may be used for various reasons including, but not limited to, zooming in or zooming out in stages. In some embodiments, the touchscreen 1042 supports a tap and hold gesture in which a user taps the touchscreen 1042 and maintains contact for at least a pre-defined time. The tap and hold gesture may be used for various reasons including, but not limited to, opening a context-specific menu.

In some embodiments, the touchscreen 1042 supports a pan gesture in which a user places a finger on the touchscreen 1042 and maintains contact with the touchscreen 1042 while moving the finger on the touchscreen 1042. The pan gesture may be used for various reasons including, but not limited to, moving through screens, images, or menus at a controlled rate. Multiple finger pan gestures are also contemplated. In some embodiments, the touchscreen 1042 supports a flick gesture in which a user swipes a finger in the direction the user wants the screen to move. The flick gesture may be used for various reasons including, but not limited to, scrolling horizontally or vertically through menus or pages. In some embodiments, the touchscreen 1042 supports a pinch and stretch gesture in which a user makes a pinching motion with two fingers (e.g., thumb and forefinger) on the touchscreen 1042 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 1042. As such, the above gestures should be understood as being illustrative and should not be construed as being limiting in any way.

The data I/O interface component 1044 is configured to facilitate input of data to the computing device and output of data from the computing device. In some embodiments, the data I/O interface component 1044 includes a connector configured to provide wired connectivity between the computing device and a computer system, for example, for synchronization operation purposes. The connector may be a proprietary connector or a standardized connector such as USB, micro-USB, mini-USB, or the like. In some embodiments, the connector is a dock connector for docking the computing device with another device such as a docking station, audio device (e.g., a digital music player), or video device.

The audio I/O interface component 1046 is configured to provide audio input and/or output capabilities to the computing device. In some embodiments, the audio I/O interface component 1044 includes a microphone configured to collect audio signals. In some embodiments, the audio I/O interface component 1044 includes a headphone jack configured to provide connectivity for headphones or other external speakers. In some embodiments, the audio I/O interface component 1046 includes a speaker for the output of audio signals. In some embodiments, the audio I/O interface component 1044 includes an optical audio cable out.

The video I/O interface component 1048 is configured to provide video input and/or output capabilities to the computing device. In some embodiments, the video I/O interface component 1048 includes a video connector configured to receive video as input from another device (e.g., a video media player such as a DVD or BLURAY player) or send video as output to another device (e.g., a monitor, a television, or some other external display). In some embodiments, the video I/O interface component 1048 includes a High-Definition Multimedia Interface (“HDMI”), mini-HDMI, micro-HDMI, DisplayPort, or proprietary connector to input/output video content. In some embodiments, the video I/O interface component 1048 or portions thereof is combined with the audio I/O interface component 1046 or portions thereof.

The camera 1050 can be configured to capture still images and/or video. The camera 1050 may utilize a charge coupled device (“CCD”) or a complementary metal oxide semiconductor (“CMOS”) image sensor to capture images. In some embodiments, the camera 1050 includes a flash to aid in taking pictures in low-light environments. Settings for the camera 1050 may be implemented as hardware or software buttons.

Although not illustrated, one or more hardware buttons may also be included in the computing device architecture 1000. The hardware buttons may be used for controlling some operational aspect of the computing device. The hardware buttons may be dedicated buttons or multi-use buttons. The hardware buttons may be mechanical or sensor-based.

The illustrated power components 1012 include one or more batteries 1052, which can be connected to a battery gauge 1054. The batteries 1052 may be rechargeable or disposable. Rechargeable battery types include, but are not limited to, lithium polymer, lithium ion, nickel cadmium, and nickel metal hydride. Each of the batteries 1052 may be made of one or more cells.

The battery gauge 1054 can be configured to measure battery parameters such as current, voltage, and temperature. In some embodiments, the battery gauge 1054 is configured to measure the effect of a battery's discharge rate, temperature, age and other factors to predict remaining life within a certain percentage of error. In some embodiments, the battery gauge 1054 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 1012 may also include a power connector, which may be combined with one or more of the aforementioned I/O components 1010. The power components 1012 may interface with an external power system or charging equipment via a power I/O component 1042.

Based on the foregoing, it should be appreciated that concepts and technologies have been disclosed herein for a quick analysis tool configured to present one or more data analysis features that are tailored to the data in a selected portion of a spreadsheet document. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method comprising computer-implemented operations for:
receiving a selection of a range of cells from a spreadsheet document;
displaying a quick analysis tool entry button in proximity to the selection of the range of cells;
determining one or more data types of data included in the range of cells in the spreadsheet document;
determining one or more data analysis features suitable for application to the one or more data types;
receiving a selection of the quick analysis tool entry button;
in response to receiving the selection of the quick analysis tool entry button, displaying one or more user-selectable representations for the one or more data analysis features;
receiving a selection of a particular user-selectable representation from the one or more user-selectable representations, the particular user-selectable representation being associated with a particular data analysis feature of the one or more data analysis features; and
in response to receiving the selection of the particular user-selectable representation, applying the particular data analysis feature to the data included in the range of cells.

2. The computer-implemented method of claim 1, further comprising computer-implemented operations for:
in response to receiving the selection of the range of cells from the spreadsheet document, determining if the selection of the range of cells includes two or more non-blank cells;
if it is determined that the selection of the range of cells includes two or more non-blank cells, then displaying then displaying the quick analysis tool entry button in proximity to the selection of the range of cells; and
if it is determined that the selection of the range of cells does not include two or more non-blank cells, then instructing the computer to not execute a remainder of the computer-executable instructions.

3. The computer-implemented method of claim 1, further comprising computer-implemented operations for:
determining if the selection of the range of cells is a first range selection after launch of a spreadsheet application configured to allow manipulation of the spreadsheet document via the one or more data analysis features;
if it is determined that the selection of the range of cells is a first range selection after launch of the spreadsheet application, then displaying a tooltip comprising information related to the one or more user-selectable representations for the one or more data analysis features; and
if it is determined that the selection of the range of cells is not a first range selection after launch of the spreadsheet application, then determining the one or more data types of data included in the range of cells in the spreadsheet document;

4. The computer-implemented method of claim 3, wherein determining if the selection of the range of cells is a first range selection after launch of the spreadsheet application comprises determining if the selection of the range of cells is a first range selection after launch of the spreadsheet application only if the launch of the spreadsheet application is within a predetermined number of launches of the spreadsheet application.

5. The computer-implemented method of claim 1, wherein receiving the selection of the quick analysis tool entry button comprises receiving the selection of the quick analysis tool entry button via a mouse click, a touch input, a voice input, or a sensor input.

6. The computer-implemented method of claim 1, wherein displaying the one or more user-selectable representations for the one or more data analysis features comprises expanding the quick analysis tool entry button to reveal a quick analysis tool comprising a gallery in which the user-selectable representations are positioned.

7. The computer-implemented method of claim 6, wherein the gallery comprises one or more tabs, each of which comprises one or more of the one or more user-selectable representations for the one or more data analysis features.

8. The computer-implemented method of claim 7, wherein the tabs are used to categorize the one or more user-selectable representations based upon categories of the one or more data analysis features.

9. The computer-implemented method of claim 7, wherein each of the tabs comprises one or more of the one or more user-selectable representations for the one or more data analysis features within a conditional formatting category, a sparklines category, a charts category, a tables category, or a totals category.

10. A computer, comprising:
a processor; and
a computer-readable storage medium in communication with the processor, the computer-readable storage medium comprising computer-executable instructions stored thereupon which, when executed by the processor, cause the processor to
receive a selection of two or more cells within a spreadsheet document; and
in response to receiving the selection of the two or more cells within the spreadsheet document, display a quick analysis tool user interface on a display screen that is operatively connected to the computer, the quick analysis tool user interface comprising one or more user-selectable representations for one or more data analysis features that are applicable to data included in the two or more cells.

11. The computer of claim 10, wherein the quick analysis tool user interface further comprises a feature gallery, the feature gallery comprising the one or more user-selectable representations for the one or more data analysis features.

12. The computer of claim 11, wherein the one or more user-selectable representations comprise one or more icons or one or more text descriptions.

13. The computer of claim 11, wherein the one or more user-selectable representations comprise one or more icons and one or more text descriptions.

14. The computer of claim 11, wherein the quick analysis tool user interface further comprises one or more tabs, each of the one or more tabs comprising one or more of the one or more user-selectable representations.

15. The computer of claim 14, wherein the one or more tabs each comprise a label indicative of a category of data analysis features included therein.

16. The computer of claim 10, wherein the computer-readable medium further comprises computer-executable instructions stored thereupon which, when executed by the processor, cause the processor to execute one or more algorithms to determine, based at least in part upon one or more data types associated with the data included in the two or more cells, the one or more data analysis features that are applicable to the data included in the two or more cells.

17. A computer-readable storage medium comprising computer-executable instructions stored thereupon which, when executed by a computer, cause the computer to:
receive a selection of two or more cells within a spreadsheet document; and
in response to receiving the selection of the two or more cells within the spreadsheet document, display a quick analysis tool user interface on a display screen that is operatively connected to the computer, the quick analysis tool user interface comprising one or more user-selectable representations for one or more data analysis features that are applicable to data included in the two or more cells.

18. The computer-readable storage medium of claim 17, wherein the quick analysis tool user interface further comprises a feature gallery, the feature gallery comprising the one or more user-selectable representations for the one or more data analysis features.

19. The computer-readable storage medium of claim 17, further comprising computer-executable instructions stored thereupon which, when executed by the computer, cause the computer to:
receive a non-selection focus of a particular user-selectable representation from the one or more user-selectable representations, the particular user-selectable representation being associated with a particular data analysis feature of the one or more data analysis features; and
in response to receiving the non-selection focus of the particular user-selectable representation, display a preview of the particular data analysis feature.

20. The computer-readable storage medium of claim 17, further comprising computer-executable instructions stored thereupon which, when executed by the computer, cause the computer to execute one or more algorithms to determine, based at least in part upon one or more data types associated with the data included in the two or more cells, the one or more data analysis features that are applicable to the data included in the two or more cells.
